(19) United States
(12) Patent Application Publication
(10) Pub. No.: US 2014/0136958 A1
(43) Pub. Date: May 15, 2014

(54) RELATING TO DISTRIBUTED ACCESS INFRASTRUCTURE FOR A DATABASE

(71) Applicant: CUSTOMER SYSTEMS PLC, Chertsey Surrey (GB)

(72) Inventors: Duncan Scattergood, Chertsey Surrey (GB); David Richards, Chertsey Surrey (GB)

(73) Assignee: CUSTOMER SYSTEMS PLC, Chertsey Surrey (GB)

(21) Appl. No.: 13/678,028

(22) Filed: Nov. 15, 2012

(51) Int. Cl. G06F 17/00; G06F 3/01; G06F 17/30

(52) U.S. Cl. 715/236; 707/610; 715/744; 707/E17.032

(57) ABSTRACT

A database management system is described which includes a central database for storing records, the system being arranged to provide a Graphical User Interface (GUI) for a remotely-located mobile device to operatively interface to the central database, wherein the GUI comprises a hierarchy of graphical elements. The system further comprises: a logic module for determining how to arrange and output information retrieved from records in the central database and for outputting that information in an XML form; and a user interface module arranged to convert the information in XML form output of the logic module into a mark-up language suitable for a browser in a mobile device, using XSLT stylesheets, wherein the XLST stylesheets are organised in a hierarchical structure which maps onto the hierarchy of graphical elements within the GUI.

### FIELD OF THE INVENTION

The present invention concerns improvements relating to distributed access infrastructure for a database and more particularly, though not exclusively, to integration of mobile device access with a central database such as a Customer Relationship Management (CRM) database.

### BACKGROUND

Customer Relationship Management (CRM) refers to the processes by which an organisation manages its interactions with customers and prospective customers. This exercise encompasses all customer facing aspects of a business, such as sales, marketing, customer service and technical support. Objectives include winning new business, retaining existing customers and maximising revenue through up and cross-selling activities.

CRM activities often require access to large amounts of information and the following of complex processes and rules established by the organisation. CRM software packages seek to allow access to and creation of such data, processes and rules.

Users of CRM applications traditionally access information through the use of a desktop or laptop computer.

FIG. 1 shows a typical view 10 within a CRM software package within which a user can view/amend information relating to a potential sale (an ‘Opportunity’) 10 and its key players (‘Contacts’) 14 within the prospect's organisation. In this example, information 16 about eight different contacts is shown on the single view 10.

The full feature set of some CRM applications is generally only accessible through devices incorporating specific proprietary operating systems and browser software, limiting their use on a range of devices. For example, some CRM database solutions require the use of Microsoft Windows® or Microsoft Internet Explorer for Windows® or, more often, both, preventing access to the full feature set on other operating systems/devices, such as mobile platforms. Neither Microsoft Windows® nor Microsoft Internet Explorer for Windows® is normally available to run on handheld devices. Even when they are available on handheld devices, the different physical characteristics of the handheld devices normally mean the CRM application is very hard to use unless it is effectively redesigned specifically for the handheld environment.

Desktop or laptop computer access to CRM applications retrieve up-to-date data in real-time, which is often perceived as being critical in gaining the current view of the customer for best possible competitive advantage (for example through the timely response to a customer's request for service).

Desktop/laptop computer access proves inadequate for employee activities taking place out of the office, resulting in lost opportunities and decreased efficiency. For example, the need to start-up a laptop, which is time-consuming, and it being cumbersome to use whilst standing, may lead to lost opportunities to use/create CRM data which could be realised using truly mobile device such as a tablet or smart phone device.

Additionally, certain scenarios may require access to and creation of CRM data when no network connection is available, such as in the case of pharmaceutical representatives visiting doctors in hospitals, executives undertaking extensive air travel or multi-nationals conducting business in parts of the world with poor mobile internet network coverage.

When existing systems do have both connected and disconnected modes of operation, they are generally separate from each other and with different styles of user interface. One such system with both modes of operation is described below with reference to FIGS. 2 and 3. However, it is also to be appreciated that many systems are designed to only work in connected mode and cannot operate in disconnected mode to cater for a situation where no network is available, such as when they are out of range of the mobile phone network.

As mentioned above, some mobile CRM applications can operate in a connected mode where the device has a communications path available to connect to the logic of the CRM (illustrated in FIG. 2) and a disconnected mode where such a communications path is unavailable and so the device has to use local logic of the device and rely on a synchronising process to update the database of the CRM at a later stage when a communications path becomes available (illustrated in FIG. 3). Referring in greater detail to FIG. 2, a basic CRM system 20 comprises a data store 22 (typically a database) for storing the CRM data, a logic module 24 for executing rules and processes for the CRM, and a user interface (UI) rendering module 26 for adapting the output of the logic module into a graphical user interface. (The system is also referred to as a CRM application.) The output is converted into a suitable format and provided to a computer (laptop or Desktop) 28 connected to the CRM system 20 via a constant communication path 29. A mobile device 32 is shown connected to the CRM application because of the existence of a communications path 31 from the device 32 to the logic module 24 via a UI rendering module 30. This UI rendering module 30, provided at the CRM application, renders the output of the logic module 24 into a graphical user interface and then renders this into a format suitable for transmission over the wireless network 31 to the receiving mobile device 32. This connected mode of operation is characterised by its sharing of the existing CRM application's rules/processes logic module 24 and the data store 22. Different User Interface (UI) renderings are provided for the mobile device 32 and the desktop/laptop 28 front ends before being converted into a mark-up language and communicated over a network connection 29, 31 to the desktop/laptop 28 or mobile device 32.

The UI rendering module 30 addresses two purposes: firstly, if the CRM application is technically incapable of being displayed on mobile platforms (for example a CRM's full feature set which can only be viewed within Internet Explorer for Windows), the UI rendering produces a user interface which is technically capable of being displayed on the mobile platform. Secondly, the rendering may also be optimised for a smaller mobile screen size. It may also be more lightweight than the desktop version for performance delivery across mobile networks and/or rendering on a device with limited hardware resources.

Referring to FIG. 3, a disconnected mode of operation is shown in detail. This mode of operation involves the use of a standalone application 34 with its own logic module 38 and data store 36. These are shown in FIG. 3 to be part of the mobile device 32, though it is also possible for them to be provided on a remote server in an alternative arrangement (mentioned below). The mobile device 32 is not connected with the CRM application as no communications path exists between the device 32 and the CRM application. Whilst no communications path is available, the mobile device in disconnected mode uses its own logic module 38 and data store 36. However, as can be seen, once a path 39 is available, the mobile device interacts with the logic module 24 of the CRM system 20 to synchronise its data 36 to the CRM data 22. Note that the logic module 38 and/or data store 36 shown in FIG. 3 may reside on a remote server (not shown) with which the mobile device 32 communicates or on the mobile device 32 device itself (as shown), or both.

Many existing systems, which use a separate application developed for the handheld device, have better adaptation to the style of user interface which is appropriate to the particular device. However, they suffer one or both of two other problems. Firstly, since different handheld devices can have different operating systems, they have to have different software for each operating systems, which adds to the amount of software which needs to be written, and maintained and makes the situation more error-prone as accidental differences can arise between one device's software and another. Secondly, the use of a separate application means that the business logic stored in the central CRM system has to be programmed separately into the software for each device, rather than being derived automatically from the central CRM system. This creates still more proliferation of software to be developed and maintained and still more possibility for error as differences can creep in as between the central system and one or more of the separate handheld applications. It also makes the entire systems less flexible. Since a change to the business logic in the centre is not automatically reflected in all of the handheld applications, it becomes difficult to change the system at all because doing so is so arduous and risky.

As can be seen, the mobile application 34 in the disconnected mode needs to perform a synchronisation process 39 when a communications path is available whereby information is passed to/from the CRM system 20 via the logic module 24. This synchronisation may be user initiated, occur periodically, or be real-time (or almost real-time).

Whatever the mode and frequency of synchronisation with the CRM application, the defining feature of the prior art disconnected application 34 is that it implements its own business logic within its own logic module 38. That is to say, the mobile application 34 of a mobile solution which can operate in a disconnected mode is a separate standalone system, rather than an add-on to the existing CRM system 20. Thus, the logic module 38 of the mobile CRM application 34 is different to and independent of the logic module 24 of the CRM system 20.

This is inferior to a situation where the mobile application is integrated with the server-based systems and derives its business logic automatically from the server-based system.

Many existing integrated solutions have been built for older, less powerful mobile devices which had smaller screens than modern smart phones. This results in a very small amount of CRM information being displayed at any one time as can be seen in the example provided in FIG. 4. In this example, the information provided in FIG. 1 (opportunity data 12 and contact data 14, 16) is displayed using one view 40 for the opportunity data 12 itself, a separate contact view 42 listing the eight contacts (not all shown in FIG. 4) and further capable of showing only one contact record 44 at a time (requiring, in this example, the mobile user to navigate at least nine times to see all the relevant information which was displayed in a single view 10 of the desktop GUI).

This shortcoming can also lead to increased communications between the mobile device 32 and server (not shown) hosting the CRM application 20, generating more traffic on the communications channel and resulting in a much reduced quality of user experience because of high latency connections. Further, existing mobile solutions are limited to visually inferior interfaces which have contributed to these products receiving little or no adoption in practice.

More modern mobile devices (such as current smart phones) are comparatively feature-rich with the ability to provide location awareness, map integration and view a variety of file types (such as pdf agreements or contracts). Current integrated mobile applications which target older mobile devices do not take advantage of such features. This results in a greatly reduced feature set being provided by such prior art integrated mobile devices as compared with prior art desktop versions (which can view a variety of file types). Furthermore, this results in missed opportunities to provide a mobile user with CRM data relevant to their current location.

Some integrated mobile applications are known which have attempted to address at least some of the above described problems. One such prior art CRM mobile integrated application has a technical architecture which suffers from the weaknesses described below.

In the known CRM product, output in the form of XML (eXtensible Markup Language) is emitted from the prior art CRM mobile integrated application (from the logic module 24) based on the configured user interface definition (not shown) and business layer rules/processes (logic). This XML output is then transformed in the UI rendering module 30 into a graphical user interface. Finally, this XML representation is converted into HTML (Hypertext Mark-up Language) (or WML—Wireless Mark-up Language) using XSLT (Extensible Stylesheet Language Transformations) stylesheets. The resulting HTML code is sent to the mobile device 32 and is in a form capable of being displayed in a web browser (not shown) of the mobile device 32.

However, only a single XSLT stylesheet is used per view (page of the GUI to be presented). This means that a different stylesheet must be defined for every different view type (for example a list of records would use a different view type to a view detailing a single record). The skilled developer will recognise this as being one single stylesheet file per applet web template.

This becomes problematic due to the fact that many visual components of a typical web page 50 (whether targeted at a desktop, mobile or tablet device) must be common throughout the application. An example of such components is illustrated in FIG. 5 (described in detail later) which shows four different components of a web page 50, namely global navigation components 52, corporate branding components 54 and important task links 56, all of which are common to all views within the mobile application. The information specific to that page to be viewed, which changes in each web page, is confined to a specific information portion 58 of the screen 50. The components 52, 54 and 56 would have to be recreated into each different view type.

This limitation's effect is that producing a large variety of different ways in which to display data is difficult, time consuming and error prone. Furthermore, this limitation makes it impractical to reproduce within a mobile device GUI a substantial portion of the display mechanisms available in the desktop version of many CRM systems, which include (but are not limited to):
Lists of data (termed ‘list applets’)
Detail for a single record (termed a ‘form applet’)
Expandable ‘tree’ list views showing hierarchical data
Calendar of appointments
Gantt chart of activities
Charts such as pie, bar and column

Further problems are described later. These limitations greatly restrict the feature set which are used in this mobile CRM application as compared with the traditional desktop CRM application. This has contributed in the past to a low rate of user adoption and reduced or inefficient usage of CRM data using mobile applications.

FIG. 4 is an illustrative example of this problem, where three different views of an opportunity detail 40, a child contact list 42 and a child contact detail 44 within a prior art mobile integrated application are shown. This can be contrasted with the full featured desktop equivalent shown in FIG. 1. It is noted that this prior art representation also lacks any global navigation components 52 (FIG. 5) and that there are a large number of views required (three in this example) to view the information (with greatly reduced information overall).

Existing standalone mobile applications may or may not function without an internet connection. Such applications are built in standalone form using entirely independent technologies to the CRM system to which it links. This has three principal consequences:
The skills required to configure such a mobile application to a particular organisation's needs are distinct from those typically possessed by those who configure the CRM system for the organisation, making customisations both expensive and time-consuming.
Where complex rules and processes (logic) are required at the point of data entry, these must be duplicated into both the CRM application and the mobile application, resulting in increased ownership costs for the organisation and risk of inconsistencies in customer dealings. In practice, these disconnected applications provide disadvantages particularly for larger organisations. For example, it is necessary to replicate the data entry logic of the CRM application in the independent mobile application and because there are two different app development environments they may not support having identical rules.
Complications arising from data synchronisations between the distinct mobile application and the CRM system lead to increased support and maintenance costs and a loss of user confidence (resulting in lost opportunities for the use and capture of CRM data).

In addition, CRM applications feature large environment architectures which benefit from features such as redundancy and scalability. This is vital in ensuring that key data (such as business critical data) is always available to all those who can utilise it. Standalone solutions do not inherently benefit from these CRM application features, meaning that either risk of an outage is increased or cost is increased through the need for separate redundancy and scalability mechanisms.

The present invention seeks to address at least some of the above described problems. Further more specific problems are described in context in the following pages where a solution to that problem is also described.

### SUMMARY

As has been outlined above, certain CRM systems generate XML in order to allow the creation of screen formats to appear on mobile devices (such as smart phones or tablet computers), sometimes only for the display of data but more often also for the capture of data, which may represent the entry by the mobile device user of new data or the entry by the mobile device user of modifications to existing data in a database underlying the CRM system. The XML for the particular screen format is then converted according to a stylesheet written in XSLT to the final HTML code for display in a browser of the mobile device.

In the prior art, the XSLT style sheet employs no subroutines for the re-utilisation of modules of XSLT which have already been written. Whilst the XSLT language supports this capability, via the ‘include’ and ‘import’ commands for code generation, these have generally not been used.

This means that the total amount of XSLT programming in XSLT stylesheets is considerably greater with very large numbers of repetitions of the same piece of software within each XSLT stylesheet and across multiple XSLT stylesheets.

Apart from the extra effort required to create each screen format, this also makes maintenance and modification of the software harder, more onerous and more error-prone. For instance, to significantly change the look and feel of the user interface would require editing many instances of the software in which the look and feel defined, and this software would occur multiple times in multiple XSLT stylesheets.

A first aspect of the present invention addresses these problems specifically. More specifically, according to the first aspect of the present invention there is provided a database management system including a central database for storing records, the system being arranged to provide a Graphical User Interface (GUI) for a remotely-located mobile device to operatively interface to the central database, wherein the GUI comprises a hierarchy of graphical elements, the system further comprising: a logic module for determining how to arrange and output information retrieved from records in the central database and for outputting that information in an XML form; a user interface module arranged to convert the information in XML form output of the logic module into a mark-up language suitable for a browser in a mobile device, using XSLT stylesheets, wherein the XLST stylesheets are organised in a hierarchical structure which maps onto the hierarchy of graphical elements within the GUI.

The first aspect of the present invention involves making use of subroutine capabilities to re-utilise software and make sure that no piece of software ever needs to be duplicated.

As described above, the present aspect of the invention implements a hierarchical architecture of XSLT stylesheets which maps to the natural hierarchy of elements within the user interface. An application may contain more than one view and a view may contain more than one applet which may be of different types and an applet may contain more than one control. The architecture is such that the behaviour which is dependent on a particular level in the hierarchy is documented in an XSLT file for each instance of that level in the hierarchy. This guarantees that duplication of software is not required. In addition, certain CRM systems do not communicate, via the XML generated, any information to allow the XSLT to detect what type of component is to be rendered, e.g. whether it is a list applet or a form applet. This means that, where several screen formats use the same set of components, but in a different sequence, these screen formats must be written as separate XSLT stylesheets, which contain the same software as each other to deal with different applet types such as list applets and form applets but with the relevant sections in different sequences.

This, again, leads to much larger amounts of XSLT software being written, due to the repetition, and also leads to maintenance and modification of the software being harder, more onerous and more error-prone.

A second aspect of the present invention addresses these problems specifically. More particularly, according to the second aspect of the present invention there is provided a method of creating a graphical user interface (GUI) representing data records stored in a central database suitable for viewing in a browser of a remote mobile device, the GUI comprising a plurality of graphical elements, the method comprising: receiving information from the data records of the central database; determining how to arrange and output the retrieved information and outputting that information in an XML form; converting the information output in the XML form into a mark-up language using XSLT stylesheets; wherein the determining step comprises using an XML parameter to specify an element type for a graphical element and the converting step comprises reading the element type parameter and retrieving a mark-up language code fragment associated with that type of graphical element.

This aspect involves forcing the database application, such as a CRM application, through unconventional means, to reveal the applet type in a coded form within the XML generated and then having the XSLT software extract the coded form of the information required. The unconventional means of achieving this involves causing the CRM application to encode the applet type into a parameter which was not intended for this purpose but which is communicated into the generated XML.

In the prior art, some products which render certain CRM systems onto mobile devices make no attempt to adapt their behaviour to the different environments of the possible devices which could be used. This assumes that a user interface which is suitable for a tablet device is also suitable for a smart phone device even though the screen sizes are quite different. This results in a user interface which is not optimised visually or ergonomically for each device.

Some other known products utilise wholly separate software written for the environment of each type of device. This makes it very hard to maintain as any development of the product must be rolled out through multiple suites of source code.

A third aspect of the present invention addresses these problems specifically. More particularly, according to the third aspect of the present invention there is provided a method of creating a graphical user interface (GUI) representing data records stored in a central database suitable for viewing in a browser of a remote mobile device, the method comprising: detecting the type of mobile device for which the GUI is to be generated; retrieving information from the data records of the central database; determining how to arrange and output the retrieved information and outputting that information in an XML form; the determining step comprising selecting a user interface configuration matched to the type of mobile device detected by the detecting step; converting the information output in the XML form into a mark-up language using XSLT stylesheets; the XSLT stylesheets conforming to the user interface configuration determined by the determining step; and generating the GUI in a form compatible with the mobile device.

This third aspect deals with different mobile devices using a single body of software written so as to be capable of running unmodified on all supported environments. The present aspect involves detecting the type of device in use and calling a very small piece of software which is particular to the needs of that environment and which sets up the shape and size and parameters of the user interface so as to be appropriate to that environment.

A fourth aspect of the present invention is a combination of the first, second and third aspects. More particularly, according to the fourth aspect of the present invention there is provided a method of providing a Graphical User Interface (GUI) for operatively interfacing a remotely located mobile device to a database management system, wherein the GUI represents data records stored in the central database suitable for viewing in a browser of a remote mobile device and the GUI comprises a hierarchy of graphical elements, the method comprising: detecting the type of mobile device for which the GUI is to be generated; retrieving information from the data records of the central database; arranging and outputting information retrieved from records in the central database in an XML form, the arranging step including using an XML parameter to specify an element type for a graphical element and selecting a user interface configuration matched to the type of mobile device detected by the detecting step; and converting the information in XML form into a mark-up language suitable for a browser in the mobile device, using XSLT stylesheets, the XLST stylesheets being organised in a hierarchical structure which maps onto the hierarchy of graphical elements within the GUI and conforms to the selected user interface configuration, the converting step including reading the element type parameter and retrieving a mark-up language code fragment associated with that type of graphical element.

The first, second and third aspects when combined together have a synergistic effect which makes it possible to create a rich user interface with many views, many applets and a mixture of many different types of applet, to run on different styles of device, without the need to write impractically large amounts of XSLT, and without the need to write software specific to the mobile device type. This means that without these aspects, the constraints of writing only a practical amount of XSLT leads to the limitation of the prior art typically producing a simpler screen format, with a very limited number of applets and types thereof, and with the data required to achieve the business function having to be displayed across multiple separate screen formats.

These three aspects together also provide developers, who have no knowledge of XSLT, the ability to craft their own screen formats by assembling ready-made components which can be provided by a third party using standard skills in the development toolkit associated with certain database applications such as CRM applications.

The three aspects together make it possible for us to easily deal with a new applet type by starting from the software we have developed for a similar applet type and defining only what differs in the new type.

Certain CRM applications linked to certain mobile applications running on mobile devices incur an unnecessary performance overhead, when dealing with multiple rows of data, where the user interface is partitioned into rows, with each row representing a data record from the central database. In order to control the behaviour of the application in terms of a given row, it is necessary to access information stored in the central database which describes attributes specifically associated with that row. One example would be to establish whether a particular row is allowed to be deleted. For instance, it could be deemed to be wrong to allow the deletion of an account which had opportunities stored against it, but right to allow the deletion of an account which had no opportunities stored against it. Another example would be that some or all of the information related to an order could be deemed read-only and therefore not open for edit in the mobile application because the order had already been despatched whereas editing could be acceptable in the case of an order which had not yet been despatched.

In order to discover this information, the mobile application needs to obtain it, for each row, from the central server where the central CRM database is held, and this will normally require communication across the mobile phone network. In the prior art, this information is obtained, one row at a time, each time the user of the mobile application highlights or selects the particular row. So, the first time a row is highlighted or selected, the relevant information for that row is requested from and obtained from the server. Then, as the user moves through each row, selecting them one at a time, a communication is instigated with the server individually for each row to request and obtain the relevant information from the server just for that row in isolation.

Because of the high latency (fixed time required to have a communication to and from the server across the network) of mobile phone communication, this creates a noticeable delay as each row is selected. It also requires far more time in total than would have been needed to bring all of this information down to the mobile device in a single communication.

A fifth aspect of the present invention addresses these problems specifically. More particularly, according to the fifth aspect of the present invention there is provided a method of generating a Graphical User Interface (GUI) for output to a user terminal, the GUI providing a graphical representation of data records stored in a central database, the method comprising: retrieving information from the data records of the central database; the information comprising value data of different data fields within a data record; determining how to arrange and output the retrieved information and outputting that information in an XML form; the determining step including defining a plurality of graphical regions of the GUI each representing a record of the central database; and converting the information output in the XML form into a mark-up language using XSLT stylesheets; wherein the retrieving step comprises retrieving behavioural information with the value data, the behavioural information specifying a type of behaviour of a data record and the determining step comprises providing a graphical sub-element in the GUI representing that behaviour.

At the heart of the fifth aspect is the feature that at the same time as the visible data for the rows is accessed, all of the required data to govern the behaviour of each row is also downloaded to the mobile device. This additional information advantageously eliminates this prior art delay and allows much faster operation of the mobile application.

In an embodiment of the present aspect, the integrated CRM mobile application minimises client-server communications, thereby providing highly improved performance.

The fifth aspect of the present invention also provides a performance advantage in the context of a CRM application running on a PC connected via a local area network or wide area network. However, the advantage is greater in the environment where the user is working with an application on a mobile device connected to a server via the mobile telecommunications (including a wireless part) network as has been described above.

As has been described earlier, there are real issues with the way in which disconnected CRMs and connected CRMs work. They are considered to be different solutions to a different set of environmental conditions.

A sixth aspect of the present invention addresses these problems specifically. More particularly, according to the sixth aspect of the present invention there is provided a module for generating a graphical user interface (GUI) on a browser of a mobile device, the module being operable in an online mode with user-interaction activity occurring with a central database of a database management system and in an offline mode with user-interaction activity occurring with a local database of the mobile device when the mobile device is not able to communicate with the central database management system, the module comprising: a receiver for receiving metadata information describing data provided within the central database of the database management system; and a user interface generator arranged to generate the GUI for the on-line mode using a database structure provided by the central database management system and for generating the GUI for the off-line mode using a local database structure to which the received metadata information has been applied.

In an embodiment of the sixth aspect of the present invention, a mobile application combines, within the same application and the same consistent user interface, visible on the same menu, a disconnected mode of operation with a connected mode. In the disconnected mode, when no connection is available to the central CRM database, the mobile application operates with a local database on the mobile device. In connected mode, when a connection to the central CRM database is available, for instance via the mobile phone network, then the mobile application operates with data in the central database.

In addition, and in contrast to the prior art, substantial amounts of the business logic used to govern the rules of operation of the mobile application are derived automatically from meta-data (data describing the structure and meaning of business data) already available in the central CRM database.

An important advantage afforded by an embodiment of the sixth aspect over known prior art is the combination of seeking to take advantage of the superiority of integrated solutions in supporting complex, heavily customised rules and processes defined within, for example, the CRM application without resorting to impractical duplication of logic, whilst accepting the practical need for business-critical functions to be performed in the absence of an internet connection (but not attempting to re-create the entire complexity of the CRM system within the standalone application).

As has been described previously, the synchronisation of a local database on a mobile with a central database (such as a CRM application) is a significant issue for all mobile implementations that have disconnected modes of operation.

A seventh aspect of the present invention addresses these problems specifically. More particularly, according to the seventh aspect of the present invention there is provided a module for synchronising offline activity occurring on a database of a mobile device with a central database of a database management system, the offline activity occurring when the mobile device is not able to communicate with the database management system, the module comprising: a receiver for receiving information describing a data structure provided within the central database from the database management system and content data for the data structure; applying means for applying the received information to a basic database structure provided on the mobile device and storing the resultant tailored database as a serialised data structure in a data store of the mobile device; population means for populating the serialised data structure with the received content data; a user interface generator for generating a graphical user interface on a browser of the mobile device using the database structure and displaying the received data; the user interface being arranged to enable user editing of or addition to the received data; tracking means arranged to track all user changes to the received data; and synchronisation means for synchronising the mobile device database with the central database by uploading the data of the mobile device database to the central database when the mobile device can operatively communicate with the database management system over a communications channel.

The seventh aspect of the present invention provides a new generic method of creating a local database on the mobile device from data structures extracted from the central database in the CRM system and updating the central database to take account of changes made remotely on the mobile device. This aspect takes any required set of data structures on the mobile device and serialises them into a data store on the mobile device. Both the data in the object instances and their relationships are captured and changes are tracked since the download from the central database. Thus a complete history of the modifications to the original data structures is created which can be submitted back to the central database for synchronisation.

An embodiment of the present aspect of the present invention provides an entirely generic synchronisation and change tracking component for use with a standalone mobile application.

In an embodiment of the seventh aspect, both the extraction logic and the synchronisation logic are governed automatically by the meta-data (data describing the structure and meaning of business data) already available in the central database or other database. This means that any customisation of the central system is automatically catered for in the extraction and synchronisation logic.

Embodiments of the present invention include some or all of the above described aspects. Some of the additional advantages and salient features of these embodiments are set out below.

An embodiment of the present invention provides an integrated CRM mobile application with a well-defined technical architecture. This facilitates a large variety of ways for displaying data. By providing these different techniques, the problem of using one XSLT stylesheet per transformation per view is avoided and the User Interface for the mobile device can be made to be consistent with the desktop UI for the full CRM application.

An embodiment of the present invention provides an integrated CRM mobile application optimised to the range of functionality available on current mobile devices. These functions include integration with mobile device features such as mapping and GPS.

Another embodiment of the present invention provides an integrated CRM mobile application capable of re-using user interface definitions across a variety of mobile device classes, whilst rendering different wireframes (structure which separates graphical elements of a web page from functional elements of the web page and an example is shown in FIG. 4).

An embodiment of the present invention can also provide a web-delivered CRM standalone mobile application which is truly independent of the mobile device on which it is used.

Also the integrated CRM mobile application provided by an embodiment which can work in both connected and disconnected modes advantageously allows customisation and extension by customers, requiring only the skills which are naturally required for customisation of the appropriate CRM system itself

An embodiment also advantageously provides a CRM mobile applications which can operate in both connected and disconnected modes, and which modes of operation are integrated in a manner seeming to represent a single application from a user perspective. In particular, the mobile application provided on the mobile device has different dedicated non-overlapping regions for both disconnected operation and connected operation. The connected options are automatically disabled when no connection to the server is available.

An embodiment provides a new way of solving the inherent mobile device access limitations of some prior art CRM applications. This results in increased opportunities for use and capture of CRM data, increasing business effectiveness and improving data quality through enabling data entry at the point of capture.

In one non-limiting embodiment, a CRM-specific integrated application can be created which can operate in both connected and disconnected modes. Such an application gains many benefits over standalone applications or applications which need different logic for the connected and disconnected modes or operation:
Complex (and potentially heavily customised) CRM business rules and processes are by definition re-used across both classical CRM access and the integrated application, ensuring consistent dealings with customers and increased user adoption and efficiency due to these processes being applied in real-time, as opposed to conflict issues being addressed by users when a later synchronisation occurs. This also results in reduced cost of ownership, both in terms of development and on-going support.
The ability to rely upon the existing CRM environment architecture, benefiting from such (often costly) features as redundancy, scalability and backups.
The ability for the existing CRM technical team to configure the application using existing skills, leading to faster capture of business change and consistency between classical and mobile CRM accessed user interfaces.

Integrated applications do exist within related prior art systems. However, embodiments of the present invention offer several improvements:
The implementation of a true technical architecture, separating the various user interface components. This allows a significantly wider variety of means for displaying data, as well as combining multiple means within the same view, resulting in increased user adoption and improved usage of CRM data to increase user effectiveness.
Integration with modern mobile operating system features such as mapping, email, file viewers and GPS. This allows a user to be more efficient and effective by giving information relevant to their current location, allowing access to important documents and facilitating fast communication with customers.
The ability to re-use the same user interface definitions across mobile devices of different sizes, providing an altered user interface for e.g. tablets compared with smart phones. This allows users to utilise larger touch screen devices more effectively, whilst not requiring unnecessary duplication of user interface definitions, ensuring faster realisation of business change and consistency for users across their different devices.
Innovations resulting in a reduced number of server communications arising from the need to set focus on a record before acting upon it. These innovations greatly improve both real and perceived performance, leading to increased user adoption and better data quality through the ability to use the application in front of a customer.

An embodiment of the present invention creates a disconnected mode of operation of the CRM application, which is capable of use in the absence of a network connection back to the database server. The advantages of this embodiment over the prior art are:
An entirely web-delivered product, allowing total device independence, which increases user adoption through their ability to utilise their device of choice. The ability to support ‘bring your own device’ initiatives may enable reduced cost of ownership for the enterprise.
The ability for customers to entirely customise the application views and create new views using a control library framework. In addition, due to the use of web technologies, customers are able to write their own business logic to truly tailor the application to their CRM needs.
A generic synchronisation mechanism capable of modelling any subsets of CRM data (both the objects and the relationships between them) without any client-side modification. The application also handles, in a generic manner, change tracking and message rebuilding for submitting alterations back to CRM. In addition, this synchronisation (and therefore the whole disconnected mode of operation of the application) may be readily ported to any CRM system capable of exposing such data structures to external systems, decreasing enterprise tie in to a particular CRM system, enabling more rapid capture of business change and reducing synchronisation errors.

An embodiment of the present invention provides an integrated application which can operate in both connected/online and disconnected/offline modes, from the user's perspective, as one seamless application. This provides the advantages of both application types or both modes of operation, with the primary access mechanism being via an integrated application which re-uses the highly-complex and potentially highly-customised CRM business rules and processes, whilst accepting the practical need for a disconnected fallback mode of operation for critical processes which must be performed in the absence of an internet connection. Some of the advantages of this embodiment are:
A powerful technical architecture allowing for a fully featured, extensible CRM user interface with a large variety of means for displaying data
A modern, touch-optimised user interface capable of integrating with features available in modern mobile operating systems
Minimising server communications from the user interaction device or terminal for faster performance and an improved user experience

### BRIEF DESCRIPTION OF THE DRAWINGS

In the drawings:

FIG. 1 is a screenshot of a prior art CRM software view showing an opportunity and customer contacts;

FIG. 2 is a schematic block diagram showing the architecture of a traditional desktop accessed CRM application with the addition of an integrated mobile solution;

FIG. 3 is a schematic block diagram showing the architecture of traditional desktop accessed CRM application with the addition of a standalone mobile solution;

FIG. 4 is a series of screen shots of a mobile device user interface for displaying the Opportunity and customer contacts of FIG. 1;

FIG. 5 is a schematic representation of a typical known web page composition showing sections for global navigation, corporate branding, important task links and an area specific to a particular view;

FIG. 6 is a schematic diagram showing a known web-deployed CRM application architecture, with servers typically hosted within the company network and a traditional access device (a laptop or desktop computer) which communicates with the servers over HTTP;

FIG. 7 is a schematic block diagram of a web-deployed CRM application architecture according to an embodiment of the present invention where specific rendering capable of supporting mobile devices in an integrated mode is provided;

FIG. 8 is a schematic block diagram of a web-deployed CRM application architecture according to an embodiment of the present invention where data is supplied via a synchronisation operation, which in addition saves changes made within the standalone application back to CRM;

FIGS. 9A and 9B are schematic wireframes of dual mode application having an integrated (online) GUI and a standalone (offline) GUI, which illustrate shared images and styling for common areas and embedded complimentary navigation in accordance with an embodiment of the present invention;

FIGS. 10A and 10B are screenshots of the GUIs generated in accordance with the wireframes of FIGS. 9A and 9B respectively;

FIG. 11 is a schematic block diagram showing an integrated mobile application environment architecture including a mobile/tablet object manager in the application server and the ways in a mobile device interacts with the object manager in accordance with an embodiment of the present invention;

FIG. 12 is a schematic wireframe of a CRM mobile device user interface GUI showing the use and reuse of applet and control types within the view as well as between views, in accordance with an embodiment of the present invention;

FIG. 13 is a schematic block diagram showing a connected application technical architecture, with the separation of concerns for the various levels of user interface elements, in accordance with an embodiment of the present invention;

FIG. 14 is block diagram showing fragments of XML code provided in different types of templates, views and applets to effect the connected technical architecture shown in FIG. 13;

FIG. 15 is a block diagram showing an example of an applet type, and a new expanded applet type together with abstracted content which links the applet types, in accordance with an embodiment of the present invention;

FIG. 15a is a table showing an example of use of placeholders on the applet web templates of FIG. 13 with the resulting buttons displayed for several rows;

FIG. 16 is a block diagram showing a standalone (offline) mobile application running within a web browser on a mobile device providing an generic synchronisation functionality, in accordance with an embodiment of the present invention;

FIG. 17 is a flow diagram illustrating an implementation procedure for a generic local relational database constructor, which implements the generic synchronisation functionality shown in FIG. 16;

FIG. 18 is a block diagram illustrating the structure of a local relational database provided as a result of the procedure of FIG. 17;

FIG. 19 is code fragment example showing an XML response from CRM application detailing the structural definition of an integration object (data structure) as part of the retrieving field definitions step of FIG. 17;

FIG. 20 is a code fragment a corresponding GUI created therefrom which shows an example XML data structure, the XML representation of a number of instances of an integration object, and the resulting population of the various local relational database tables as an example of the creations step of FIG. 17;

FIG. 21 is a table showing ‘NetDelta’ rules for the modification of records in accordance with the tracking step shown in FIG. 17;

FIG. 22 is a schematic diagram showing a the components used to create the mobile views of FIG. 16; and

FIG. 23 is a pseudo-flow diagram showing the steps involved in the production of the mobile view of FIG. 22.

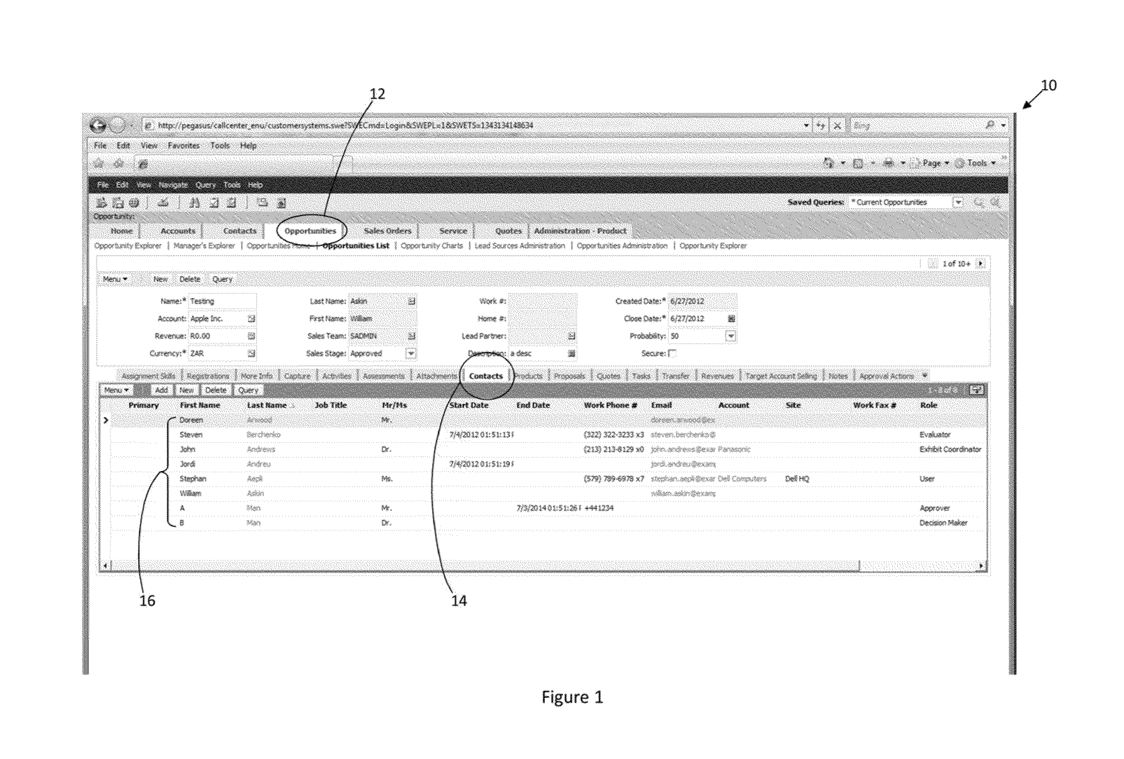

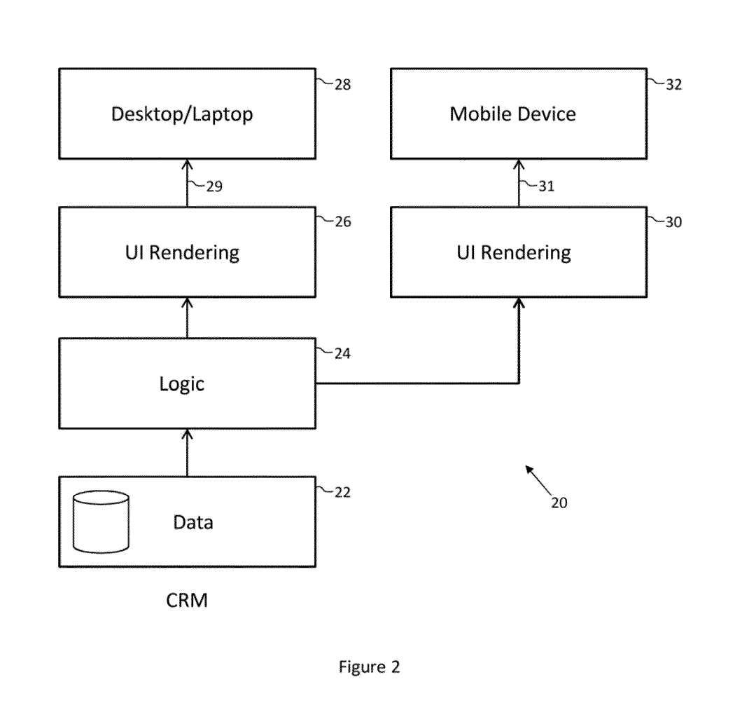

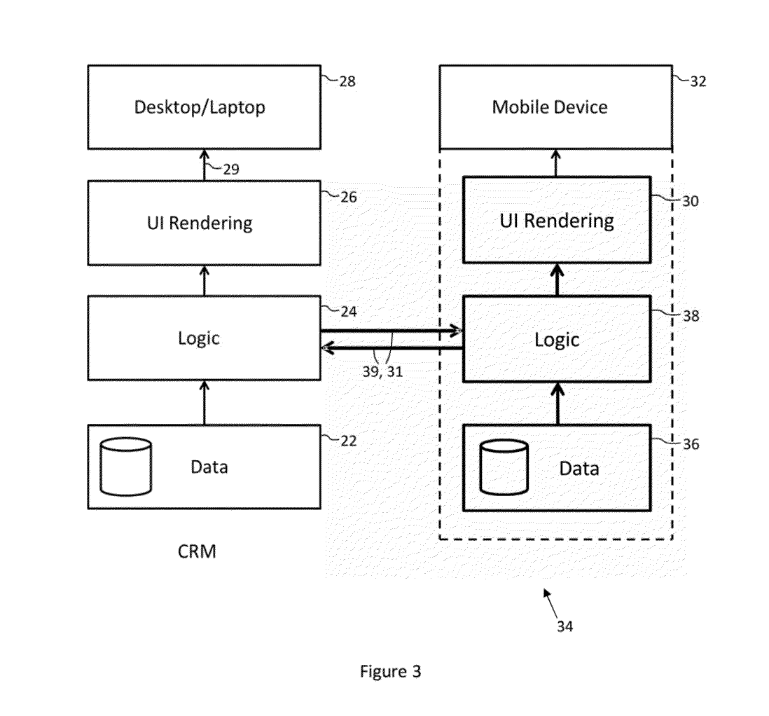

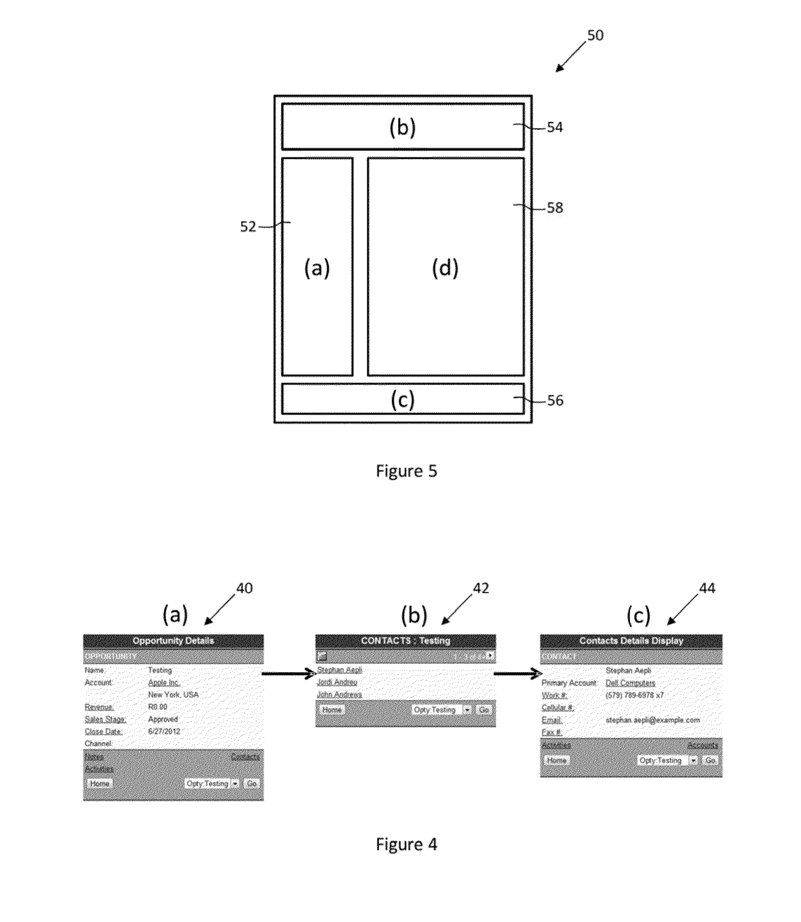

### DETAILED DESCRIPTION OF EMBODIMENTS

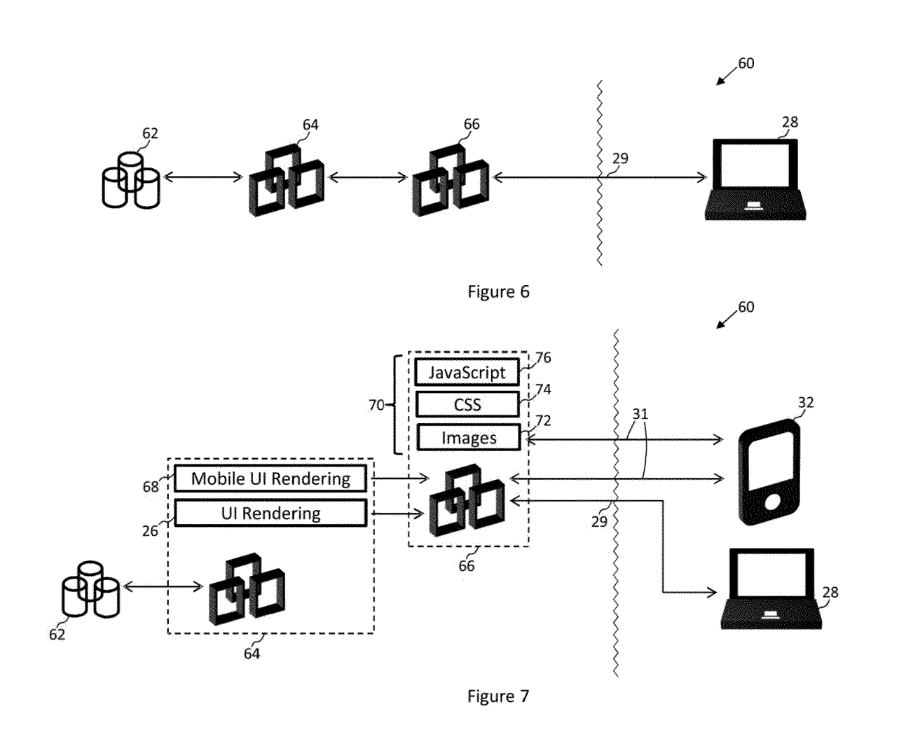

A typical prior art web-deployed CRM environment architecture 60 is shown in FIG. 6. Such an environment 60 comprises a relational database 62 which acts as the store for all data records (data store 22), an application server 64 which includes the business logic (logic module 24) and constructs the user interface views (UI rendering module 26), which is passed to a web server 66 (which converts the output of the UI rendering module 26 into HTML for output. The Web server 66 handles requests from desktop and laptop devices 28 over a wired (fixed) connection 29 and returns the user interface responses. The web server 66 also hosts various static files (such as image files, CSS (cascading stylesheets) and JavaScript files—not shown). These files are retrieved by a browser (not shown) running on the client desktop or laptop 28 based on the returned web page. In a real deployment, each of these components is sometimes replicated multiple times, to provide redundancy and scalability (in order to reduce the risk of an outage and cope with large request volumes).

An embodiment of the present invention, described below and shown in FIG. 7, functions entirely within the existing environment architecture 60 shown in FIG. 6, but allows the creation of a user interface compatible with, and optimised for, mobile devices 32. As shown in FIG. 7 (which extends FIG. 6), the application server not only comprises the UI rendering module 26 mentioned previously, but also it includes a mobile UI rendering module 68. This mobile UI rendering module 68 in the application server 64 provides a means of constructing entirely customised, mobile and touch-friendly user-interface views based on the user-interface definitions (not shown) and data retrieved from CRM database 62. Furthermore, the web server 66 comprises mobile-specific static files 70 (in the form of image files 72, CSS files 74 and JavaScript files 76) for mobile-specific resources are provided additional to the existing static files (not shown) hosted on the web server 66. These mobile-specific resources enable mobile web pages to be generated for the mobile device 32 which are better tailored to the mobile device characteristics and which enable the mobile user interface to be better matched and integrated to the non-mobile user interface as will be described in greater details below.

The present embodiment can also operate in a disconnected (offline) mode and in this regard has an offline functionality described below. The offline functionality is described and shown in the figures as a separate application for convenience of understanding but it is to be understood that this functionality is integrated into one product as will be clear when considering the Mobile UI for example.

The offline functionality is much less tightly integrated than the integrated (online) functionality, due to the need for the application to function in the absence of a connection to the server environment.

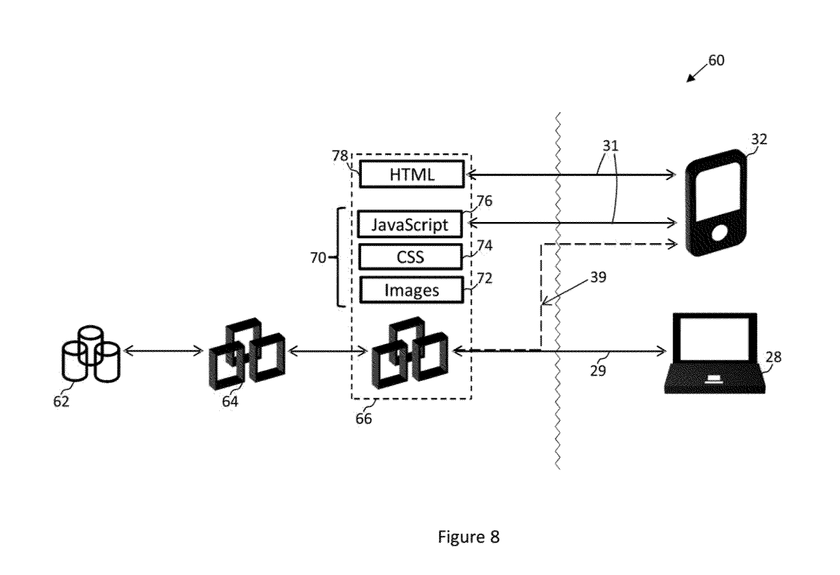

Referring to FIG. 8, the offline (not connected) application is now described. The offline application uses some of the components described in relation to the integrated application (see FIG. 7). In particular, the web server also has the mobile-specific static files 70 in addition to the existing static files (not shown) hosted on the web server 66. However, the offline application also has an offline module 78, which in the case of the present embodiment is achieved through use of HTML files, and which may or may not re-use the existing web server redundancy. The web pages which make up the GUI comprising the application are made available offline to the mobile device 32, along with other static resources (not shown) of the web server 66. When a server connection is available, data is supplied to the CRM application via synchronisation process (represented by dashed line 39) and stored locally in the database 62. The synchronisation process 39 also commits changes made by the mobile user within the offline application back to the database 62.

The present embodiment provides the functionality shown in both FIGS. 7 and 8, namely a fully-integrated mobile application capable of performing all processes defined in the CRM application, backed up by an offline application enabling the execution of a smaller number of business critical processes in the absence of a network connection 31, the two being provided as one application from a user perspective, with a common user interface providing a consistent experience for the user.

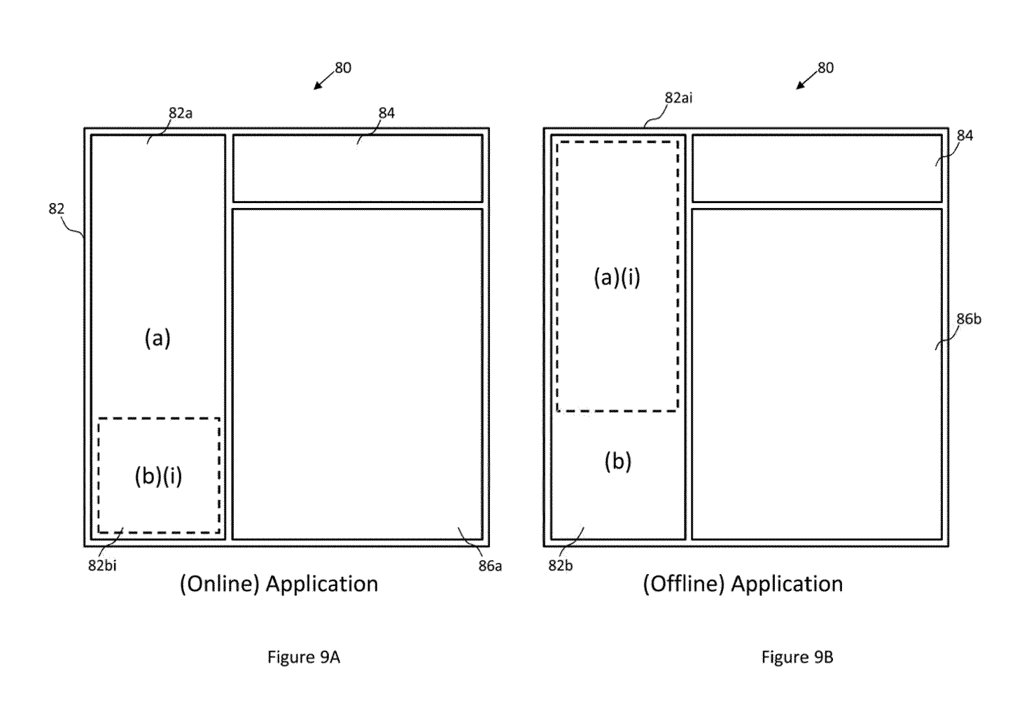

Referring to FIGS. 9A and 9B a common user interface 80 is shown where both the integrated application (shown in FIG. 9A) and offline application (shown in FIG. 9B) can be active. The two applications (which are of substantial technical difference) appear as one to a user because the same mobile-specific static files 70 (image files 72, CSS files 74 and JavaScript files 76) are used making the content of the GUI presented visually the same. FIGS. 9A and 9B generally show three areas of the GUI: a navigation section 82, a corporate branding section 84 and a content section 86 (86a and 86b). Comparing both FIG. 9A and FIG. 9B it can be seen that the size of the regions does not change between applications. However, whilst the content of the corporate branding section 84 is constant, the information presented in the respective content sections 86a, 86b changes. Nevertheless as these content sections 86a, 86b re-use the same CSS files 74 and image files 72 where appropriate, this achieves a consistent user interface 80.

The two applications' navigation sections 82 are embedded into the other, resulting in, from the user's perspective, one overall navigation section and, as such, a single application. As can be seen, the navigation section comprises an online navigation portion 82a and offline navigation portion 82b provided for within the same navigation pane 82. Within the online application (operating within the on-line, connected, integrated mode), offline navigation 82b(i) is embedded in the navigation pane 82. Similarly, whilst in the offline application (operating within the offline/disconnected mode), online navigation 82a(i) is embedded within the same navigation pane 82. Clearly only one of these navigation pane subsets is active at any one time.

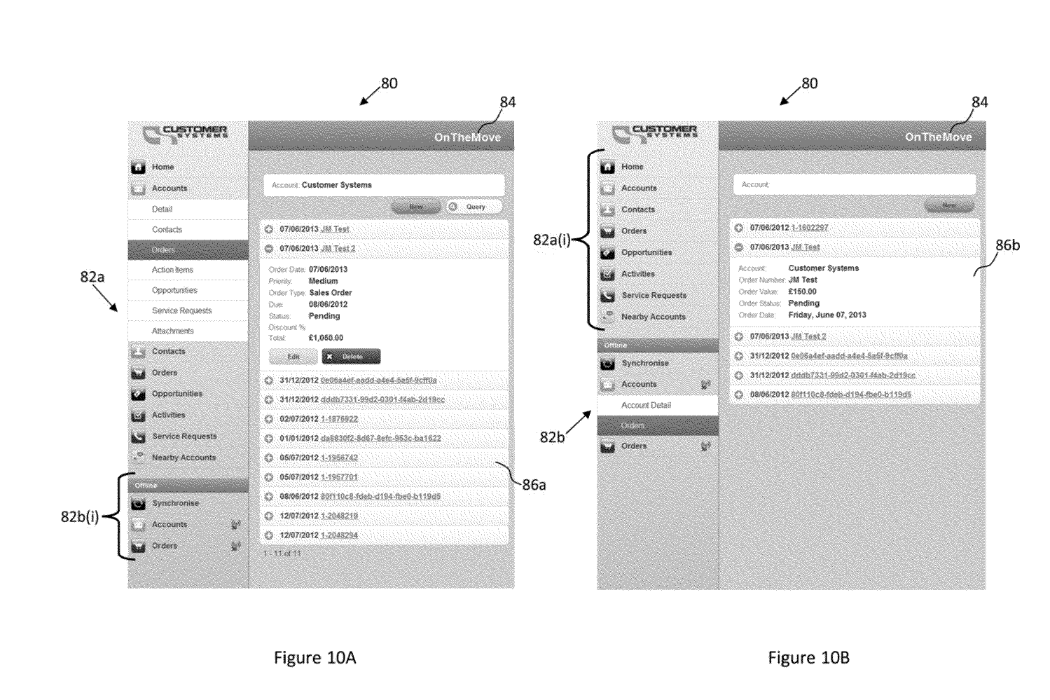

FIGS. 10A and 10B show two screenshot examples of the two applications shown in FIGS. 9A and 9B being combined. The first screenshot in FIG. 10A, shows an inactive offline navigation pane 82b(i) being embedded within the online application user interface 80 with an active integrated (on-line) navigation pane 82a. FIG. 10B similarly shows an inactive (online) navigation pane 82a(i) being embedded within the offline application user interface 80 with an active off-line navigation pane 82b. This is achieved through the use of I-frames, which is a known technique for embedding one web-page within another and so does not require further explanation herein. Note, however, that from the user's perspective, the two applications look as though they are one, with the offline application views being presented as just another area of the same application.

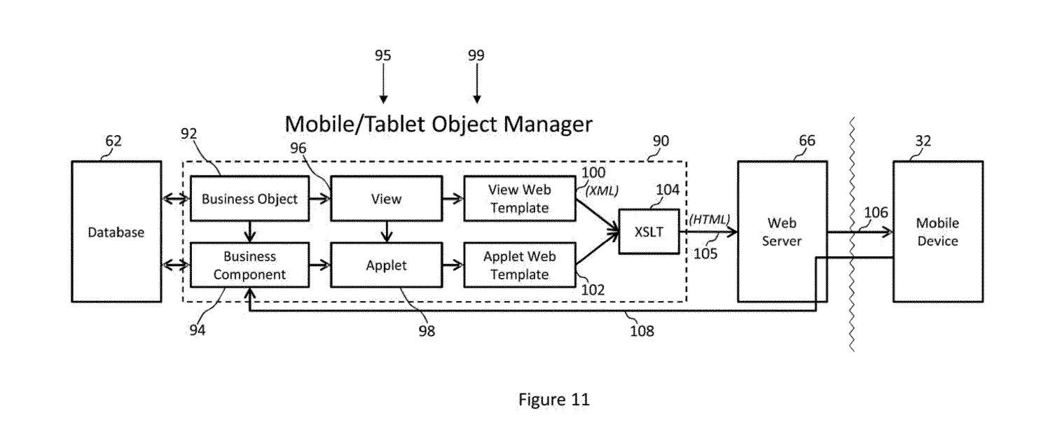

The integrated application is now described with reference to FIGS. 11 to 15. The integrated application embodiment relates directly to achieving an integrated application within CRM system and is, by the very nature of such an application type, heavily integrated technologically to the CRM system. Whilst one example of a CRM database to which the present embodiment can is described below, the innovation of providing an integrated application with both online and an offline mode of operation and the resulting benefits, are not tied to this particular embodiment. Referring to FIG. 11, the structure of an object manager 90 which is provided in the application server 64 is now described. In the present embodiment there are actually two object managers 90 provided, a tablet object manager (for use with tablet computers) and a mobile object manager (for use with mobile devices such as smart phones). The object managers 90 are provided to host two new application records which house the GUI screens for the tablet and mobile versions of the application (which are generally, but are not required to be, shared between the two). As the functionality of both object managers 90 is the same, for the sake of conciseness only one object manager 90 is described below.

The selection of the Object Manager 90 can be carried out manually by the user in some embodiments, based on their knowledge of the device type. In this case, a set number of URLs can be provided and the user chooses the appropriate one for the device type they're using (for example two URLs: tablet computer or smart phone). However, in other embodiments the selection can be automated to be matched to the device type, namely the device type can be detected and the object manager chosen based on the detected device type. In this case, CSS Media Queries can be used to determine physical sizes of an attribute of the device being used, for example screen size, and this can then be compared to a set of known values of the attribute which uniquely identify the device type. Alternatively, in another embodiment not shown, a single object manager can be used with dynamic page rendering. In this case, CSS Media Queries can again be used but this time they are called on-the-fly to vary the parameters used for output page rendering. For example, the layout can be varied based upon the detected device screen width. The skilled web developer is familiar with CSS Media Queries and their use in detecting device attributes such as screen width, and so this is not described further.

The object manager 90 comprises a business object 92 and business components 94 which make up the business object 92, which are both read from the database 62. These are the logical constructs which have to be represented in the GUI. The business object 92 and business components 94 are transformed into a graphical representation by use of the application server's UI metadata records 95. FIG. 11 shows two such UI metadata records 95, namely views 96 and components of that view, applets 98. Having created such graphical representations, they are now converted into a standard mark-up language XML by use of web templates 99 such a view web template 100 and an applet web template 102. Thus applets 98 and views 96 are created and added to the appropriate screens of the GUI in the normal manner familiar to the skilled addressee (using specific, custom web templates). Finally, the XML output by the web templates 99 is converted into HTML 105 using XSLT stylesheets 104 and sent out to the web server 66 for presenting to the mobile device 32.

The object manager 90 in this process has its output format set to XML, high interactivity set to false and JavaScript set to false. The default number of rows shown in lists can be varied to suit smart phone and tablet devices as appropriate, the device type having been either input manually or detected by use of CSS Media Queries as described above. Each Object manager has a parameter provided to enable the number of rows to be varied. Appropriate entries are made into the web server 66 to enable access to these object managers via some defined URL, in a conventional manner.

Access to the views is controlled through a conventional responsibility mechanism. When a user (who has been granted the appropriate access) navigates to the mobile or tablet URL made available by the web server 66, the server environment responds in the manner described above and outputs a response 106 to display the default view of the default screen (if the user has authenticated with the web server via e.g. active directory) or the login view (if the user is to authenticate against the database directly).

As shown in FIG. 11, the behaviour for the mobile device is identical to that which occurs when accessing a conventional object manager from a desktop computer 28, except that: the web templates 99 themselves result only in XML being produced, rather than HTML and this XML is then converted into custom HTML 105 via a process using XSLT stylesheets 104 (initiated by the web templates 99). The output HTML 105 contains links back to the web server 66 in a form which allows the user to navigate to different views with relevant context, as indicated generally by arrow 108. Views allowing alteration of records (alter, insert, delete a record) act in the same way, except that an HTML form (not shown) is used to post the alterations back to the web server 66.

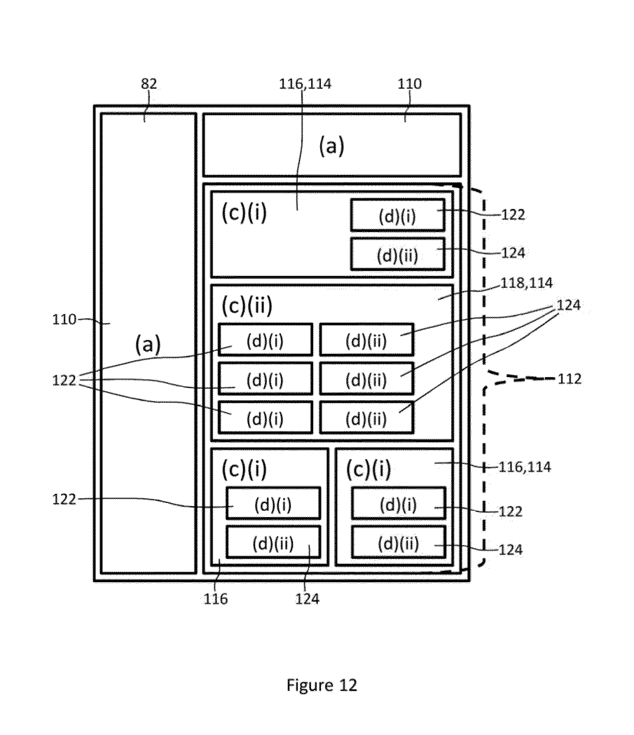

The process of generating this custom HTML 105 is significantly improved over the prior art methods in that the HTML code generation is more efficient, less XSLT stylesheets 104 are required and maintenance and modification of the software is considerably easier. The architecture which is used to support these advantages is described below with reference to FIGS. 12 to 15.

Referring now to FIG. 12, there is shown a hierarchy of graphical user interface components which are used to create a GUI. Each of these components is defined and individually manipulable to create and modify GUIs for use with both desktop computers 28 over fixed connections 29 and mobile devices 32 over wireless connections 31. At the highest level of the hierarchy, there are provided application-wide UI elements 110 (namely components of the wireframe of the GUI). One such example of an application-wide UI element 110 is a global navigation pane 82.

Within an application-wide UI element 110 a view layout element 112 can be defined. The view layout element 112 dictates the positioning of the applets 114 in relation to each other. Within a view layout element 112 the applet layout and behaviour is defined. For example, the type of applet can be defined such as a simple list 116 (c(i)), a form 118 (c(ii)), etc. At the lowest level of the hierarchy, within each applet 114, the layout and behaviour of the controls 120 (subsets of applets) is defined. For example, a control can be a button 122 (d(i)), a text box 124 (d(ii)), checkbox (not shown), a dropdown list (not shown), etc.

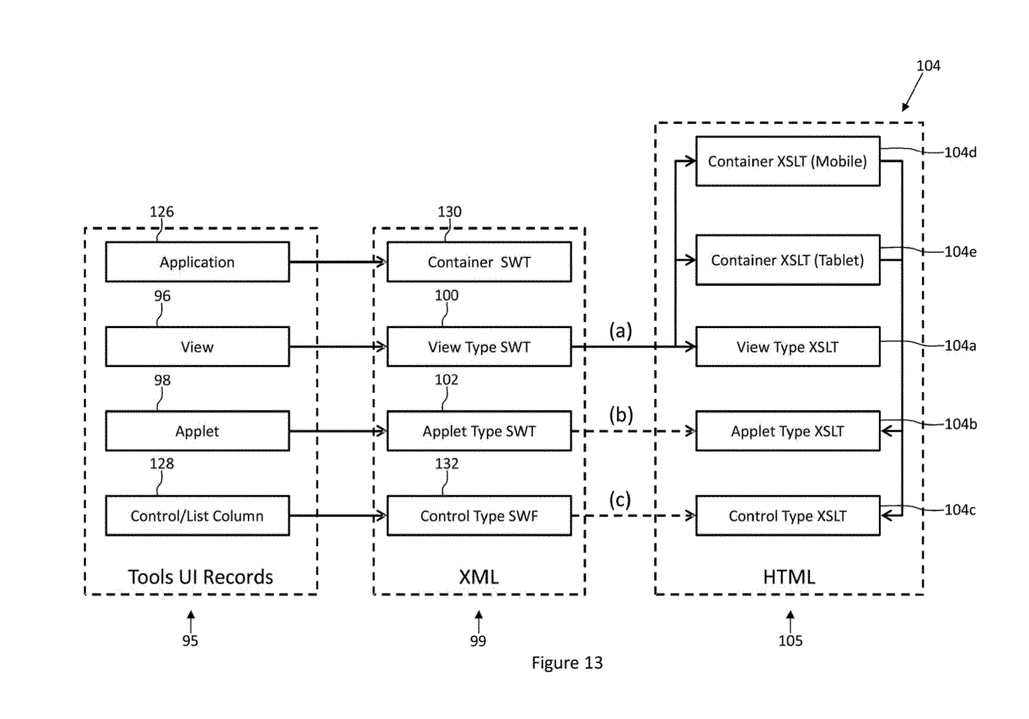

FIG. 13 shows an expanded view of how the different classes of components of the above-described hierarchy are handled by the application server's UI metadata records 95 to create custom HTML 105 using the web templates 99 and the XSLT stylesheets 104. Within the application UI metadata records 95 four different classes of UI components are handled each at a different level in the component hierarchy, namely application components 126, view components 96, applet components 98 and control/list column components 128. For each of these classes of components, a corresponding template 99 is provided. As shown in FIG. 13, the application component 126 has a corresponding container software template (SWT) 130, the view component has a corresponding view type SWT 100, the applet component has a corresponding applet type SWT 102 and the control/list column template 128 has a corresponding control type SWT 132.

For each level of the component hierarchy, a corresponding XSLT stylesheet 104 is provided to create the corresponding representation in HTML code 105. More specifically, for the view component 96, a view type XSLT stylesheet 104a is provided to create the HTML for that type of view component 96. For the applet component 98, an applet type XSLT stylesheet 104b is provided to create the HTML for that type of applet component 98 and for the control component 98, a control type XSLT stylesheet 104c is provided to create the HTML for that type of control component 128.

The view type component stylesheet 104a is used for the GUI for the desktop computers 28 which does not need to be modified for use on desktop computers 28. However, specific container XSLT stylesheet 104d is provided for a mobile device as is a specific container XSLT stylesheet 104e for a tablet computer. These stylesheets 104d, 104e are provided by the mobile object tablet managers 90 described previously with reference to FIG. 11 and provide an alternative to enable the generation of HTML matched to the requirements of the mobile device or tablet computer 32. As can be seen in FIG. 13, any XSLT stylesheet 104 for a component type can reference another stylesheet 104 of another component type which is lower in the hierarchy and simply use the code generated by that stylesheet for HTML code generation.

It is to be appreciated that not only does the above mechanism apply to different components classes (views/applets/controls) but also within each class the different types of components can also be segregated and treated independently. For example, within the class of controls 128, there may be a specific template for a button control 122 and a different template for a text box control 124.

Therefore FIG. 13 also illustrates how different GUI components are delegated to a particular XSLT stylesheet 104, which relates to the specific web template 99 for that component. Accordingly, for example, an expandable list applet web template 102 dictates that the expandable list applet XSLT (residing within the Applet XSLT stylesheet) 104b should be implemented for rendering that applet component 98.

Determining how to differentiate between different types of components within a class within XML presents another problem which has been addressed by the present embodiment and this is described below.

The XSLT stylesheet 104 is triggered via the inclusion of a “swe:xsl-stylesheet” element within the view web template 100, which references a view XSLT stylesheet 104a partnered with that view type. The view XSLT stylesheet 104a references the appropriate container XSLT 104d, 104e, depending on whether the mobile or tablet wireframe is to be used, which in turn references the applet XSLT stylesheet 104b, the control stylesheet 104c and any other useful (utility) XSLT stylesheet, which are common to both mobile and tablet wireframes.

However, as only a single “swe:xsl-stylesheet” element may be declared in all the XML produced by the web templates (container, view and applet(s)) for a given view, it is not possible to directly associate a particular applet web template with its accompanying XSLT. Such an association, as indicated in FIG. 13 is required if the ability to support a large variety of applet types and combinations thereof, is to be realised.

In the present embodiment, this association is achieved indirectly. Each applet web template 102 has, at its top level, a “swe:form” element with a “NAME” attribute set to some unique identifying value (in this embodiment the name of the web template 102 by convention). The view XSLT stylesheet 104a issues an “xsl:apply-templates” command for each applet 98 it encounters within the XML code provided by the View template 100. The Applets XSLT stylesheet 104b contains a series of templates with a match expression referring back to the “swe:form” “NAME” attribute. This match expression enables the correct applet XSLT stylesheet 104b to be executed.

Therefore, the view XSLT stylesheet 104a understands and dictates that an applet 98 should be rendered in a particular location and requests that this be performed. It does not however have any knowledge of, or interest in, the type or nature of that applet.

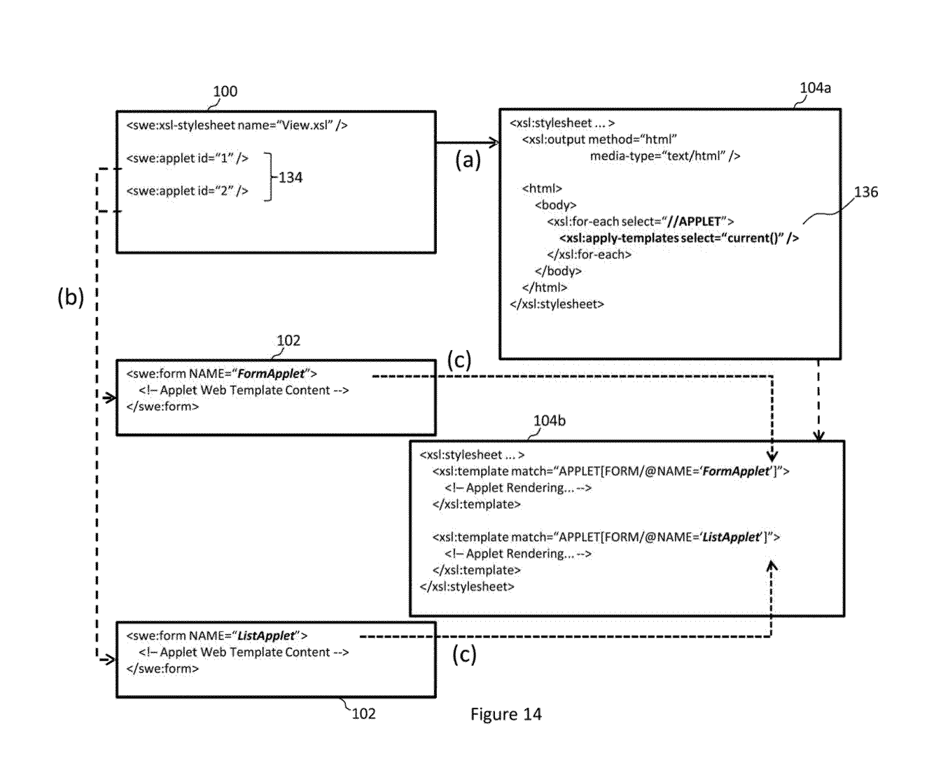

This process is illustrated in FIG. 14, with a view web template 100 having two applet placeholders 134, which for a particular view may be populated by the applet web templates 102. The view web template 100 directly includes an XSLT stylesheet 104a which renders the view, issuing an “xsl:apply-templates” command 136 from which the relevant applet XSLT stylesheet 104b is triggered, based upon the association shown in FIG. 14 by arrows (c). FIG. 14 illustrates the rendering of applets within a view. Note that the XSLT stylesheets 104b for the two applet types are separated, which in turn are separated from the view XSLT stylesheet 104a. The XML input to the XSLT process is a result of interaction between the web templates 99, the UI metadata records configuration for the applets 98 and the data for the record(s) being shown. Standard attributes and XSLT stylesheet ‘include’ statements have been removed from FIG. 14 to aid clarity.

The applet XSLT stylesheet 104b calls a template 102 in order to render each particular control 128 in the location desired by that applet 98. The XML resulting from the web templates 99 indicates which type each control 128 should be and the control child template 132 implements the control accordingly. Similar to the view-applet case described above in relation to FIG. 14, the applet 98 dictates that a control 128 should be created, but is agnostic as to the type and implementation details of that control 128.

The above embodiment brings significant advantage to a CRM user in achieving a fully-featured mobile CRM application. Examples of these benefits are outlined below.

The technical architecture outlined above allows the production of a large range of applet types, which can be employed, for example, to replicate on a mobile device the full feature set of a classic CRM user interface for a desktop computer. However, in many devices an alternative tailored GUI is required which is optimised to the limitations and capabilities of a particular mobile device. The creation of so many applet types also enables a greater range of selection options of different features for creating the optimised mobile device GUI.

Examples of some applet types produced by the present embodiment include:
A simple, clickable list (intended to contain one or perhaps two fields to uniquely describe the record);
An expandable list (with one or perhaps two fields appearing in a list which is expandable upon being touched, exposing more fields vertically in a single column);
An expandable list when the device is in portrait mode, with a cut-down number of fields available and editable in a grid-like format when the device is in landscape mode;
A detail form, exposing fields vertically in a single column, with the ability to group fields into expandable sections, each with a label;
An attachment list, showing a small number of fields to describe the record, with an image which varies based upon the file type; and
A map list which exposes a simple, clickable list on the left hand side and a map on the right hand side which plots the location of each record with a marker. Each marker is clickable, showing an information window which may contain a series of fields exposed vertically in a single column.

Another important feature of the present embodiment is that of extensibility, namely that a particular component web template 99 may be extended to produce a new component type which relies in part on, or re-uses entirely, the original component web template 99. Also the new component type may alternatively use its component child web template, for example a particular applet web template 102 may use a control template 132. Such extension is possible due to the hierarchical structure and the provision of separated component type definitions used within the present embodiment.

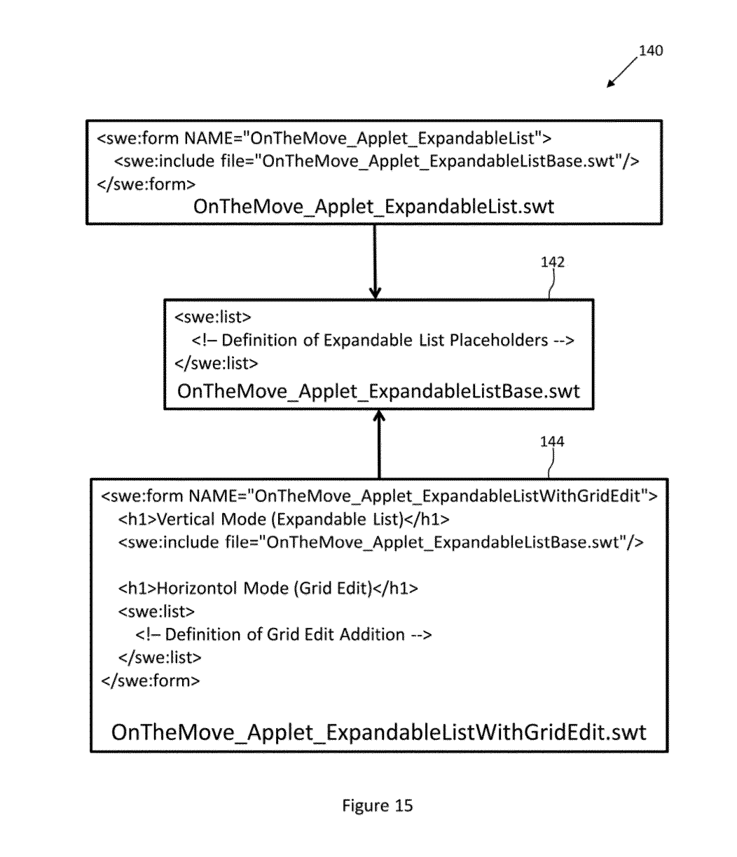

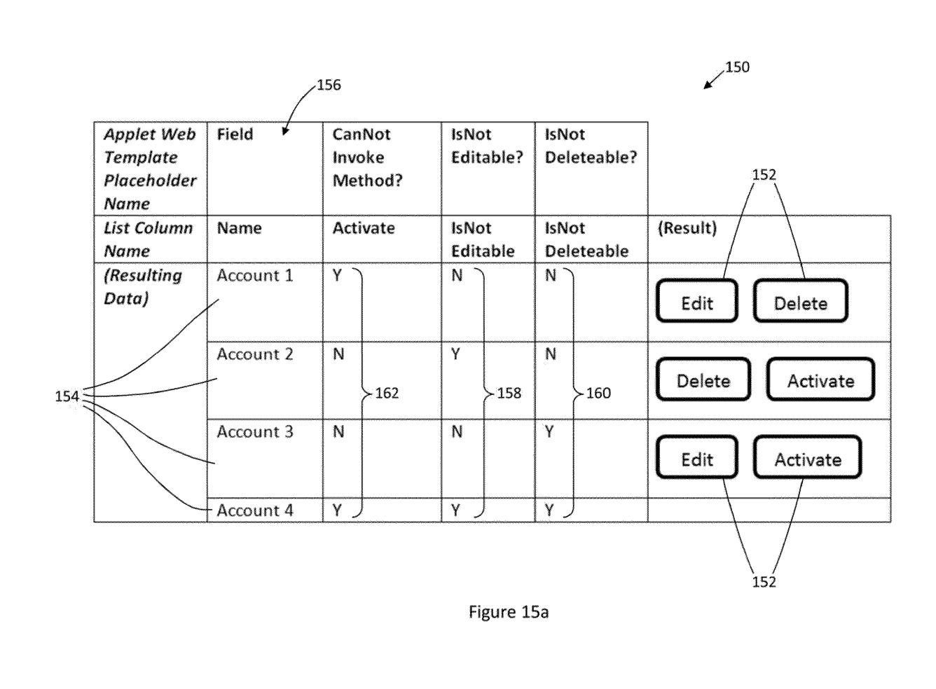

A new applet web template can be created with its own placeholders and layout, referencing the ‘base’ applet web template 102 in the appropriate location. It may be necessary to abstract the original applet web template 102 into two files, one with all the content except the outermost form (the ‘base’ file) and the other with just the outermost form and a reference to the ‘base’ file. This allows the applet association (described above with reference to FIGS. 12 and 13) to function correctly for both the original and new (extended) applet types, as shown in FIG. 15. FIG. 15 is an example of applet extensibility which shows fragments of XML code in three parts to illustrate how extension can be achieved. The three parts are: the original expandable applet type 140, the new applet type 144 and the abstracted content 142 contained within the original applet type 140. The new template type 144 is an expandable list with grid edit applet type. Note that the original expandable applet type 140 and the new expanded applet type 144 both reference the abstracted content 142, with contains all mark-up except the swe:form element for the expandable list applet type 144.

Having created the extended web template, an XSLT template within the Applets XSLT stylesheet 104b must be created, with a ‘match’ expression consummate with the new extended web template's ‘swe:form’ element ‘NAME’ attribute. Similar to the web template 99, this XSLT template can then define its own mark-up for the new applet type and, crucially, reference the original ‘base’ applet's XSLT template where appropriate (this template requires a name adding as well as a match expression such that it may be called directly).

As such, a new applet type can be created which not only extends an existing applet type, but fully re-uses its definition, such that changes to the base applet type automatically affect the new applet type.

Examples within the present embodiment include:
a Standard List Applet with Title—extends the standard (simple) list applet type, but includes a title, making it useful for homepages where a small number of e.g. ‘upcoming’ records may be shown to summarise an employee's work load; and
Expandable List with Grid Edit—extends the expandable list applet type when the device is in portrait mode, but facilitates the creation of a simple grid-like editing experience when the device is in landscape mode, allowing rapid editing of the most regularly changed data.

An embodiment of the present invention which provides an enhanced connected (integrated) CRM mobile application is now described, though it can also have an advantage in a CRM desktop application too. This embodiment addresses the problems described earlier in relation to the way in which certain CRM applications incur an unnecessary performance overhead when dealing with multiple data records partitioned into rows in a GUI. The present embodiment addresses these problems reducing latency by minimising communications required between the mobile device and the server when dealing with multiple rows of data.

As has been explained previously, certain known CRM user interfaces are arranged to function one record at a time, with the application instructing the browser as to, for example, which fields should be editable and which methods may be invoked only for that single record. As such, when viewing a list of records, a user must ‘set focus’ on a row before being able to edit it or invoke a method on that record (e.g. to delete the record, or process a particular order). This process of ‘setting focus on a record’ involves a communication back to the web server in order to retrieve the information relevant to that record and this leads to poor performance particularly when accessing the CRM environment over a mobile network with limited bandwidth.

The present embodiment partially remedies this situation by allowing an applet to indicate which methods may be invoked on which records in a list when the view is loaded. As such, whilst complex editing of records still requires that record to receive focus (to evaluate the values which should appear in drop-downs, for example) the buttons made available for editing, deleting etc. a record can be made available where appropriate (and not made available where not appropriate) without requiring ‘setting focus’.

This is achieved through the use of placeholders on the appropriate applet web templates 102 onto which a list column may be mapped to indicate that a record is not editable, deleteable etc. The XSLT stylesheet 104 then evaluates this value for each row and if it is equal to ‘Y’, the relevant button is not displayed for that row. Placeholders can control a particular, pre-determined method, name or may alternatively use the mapped list column name (or display name or similar) to dictate the method being controlled.

FIG. 15a shows a tabular example 150 of use of placeholders on the applet web templates with the resulting buttons 152 displayed for a number of rows 154. As can be seen, the example includes: a ‘normal’ data field (“Name”) 156 which is actually shown to the user; Edit flags 158, which aren't shown to the user but control whether pre-defined methods may be invoked for a particular row 154; Delete flags 160, which aren't shown to the user but control whether pre-defined methods may be invoked for a particular row; a Custom method flag (“Activate”) 162, not shown to the user but controls whether a custom method may be invoked for a particular row 154.

In addition, the present embodiment also enables editing of simple fields across multiple rows without setting focus on each record. ‘Simple’ fields are defined as those which do not vary across rows within the same view, which would exclude state model enabled fields or conditionally editable ones, for example. This definition of ‘Simple’ fields allows the assumption that the editing metadata provided in the XML for the first record is identical to that which would be provided for any other records in the same list were focus to be set on them. This metadata includes, as examples, the values with which to populate dropdowns, whether a particular field should be editable and the information needed to construct the save web request. It is therefore possible to issue one save command per row, varying only the data submitted and the row id parameter.

These enhancements over traditional user interfaces provide significant benefit to a user by greatly improving the perceived (and real) performance of the application and decreasing the number of navigations required to edit a record.

Having described a connected (integrated) application of the present embodiments, the disconnected mobile application is now described. This embodiment can be considered to be implementable with the previously described embodiments but also can be implemented independently of those embodiments. The disconnected CRM application is used primarily for the purposes of a CRM which is powered entirely by client-side web technologies, capable of synchronising data to/from the master CRM system (application) and having the ability to create user interface views allowing a user to modify, delete and add to CRM data. Critically, the latter is possible in the absence of a network connection to the master CRM system (and any internet connection in general) and the disconnected mobile application is not tied to any particular, or set of particular, mobile operating systems. In addition, the present embodiment advantageously may be ported for use with various different CRM applications.

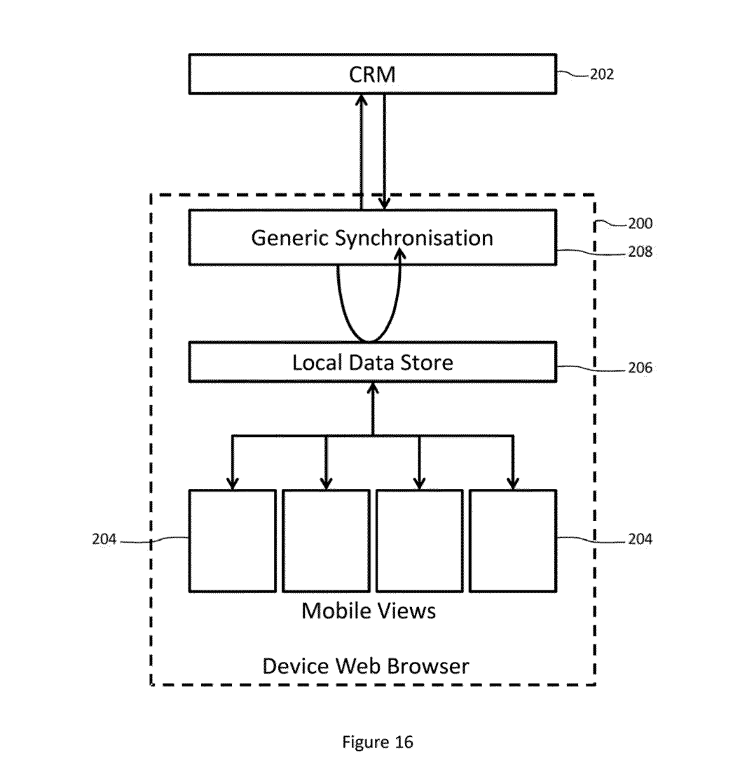

Referring to FIG. 16, a high-level functionality of the present embodiment is now described. The mobile device 200 operates in a disconnected mode from a master CRM application (CRM system) 202. As has been described before, this involves the mobile device 200 operating independently of the master CRM application 202, generating mobile views 204 of the CRM data and data structures for viewing on a browser of the mobile device 200, storing input data and updates to the CRM data and data structures in a local data store 206 and, at a certain time, the mobile device 200 performs a generic synchronising function 208 with the master CRM application 202 to update it with all activity which has occurred on the mobile device 200. Whilst in the prior art systems, there are issues with the synchronisation caused by the independence of the CRM applications with the mobile device (described previously) the present embodiment obviates some of these problems by providing knowledge of the CRM data structures to the mobile device local data store 206 which can then be used by the mobile application to provide a compatible context for user interaction with that data.

More specifically, the CRM 202 has a set of CRM objects (such as Account, Contact, Opportunity, etc.) which can be arranged into hierarchical structures showing the various relationships between instances of the CRM objects, suitable for working with a particular subset of the CRM application. In many CRM applications, the resulting data structures may be represented in a format retrievable by external systems.

In the present embodiment, the mobile device 200, running its own disconnected CRM application, is capable of taking any set of data structures present in the master CRM application 202 (without requiring knowledge as to their structure definitions) and ‘downloading’ them and storing them in a serial form (such as in a table) in the local data store 206. This enables the capturing of both the data in the object instances (e.g. an Account name, status, type, etc.) and the relationships between the various instances. Further the mobile application then tracks changes (including record deletions) and additions to the local data store 206 occurring since the ‘download’ operation. This history of activity on that data is used to subsequently re-create each of the original data structures with the modifications and additions and these can then be submitted back to the master CRM application 202 in order to synchronise the mobile user's changes.

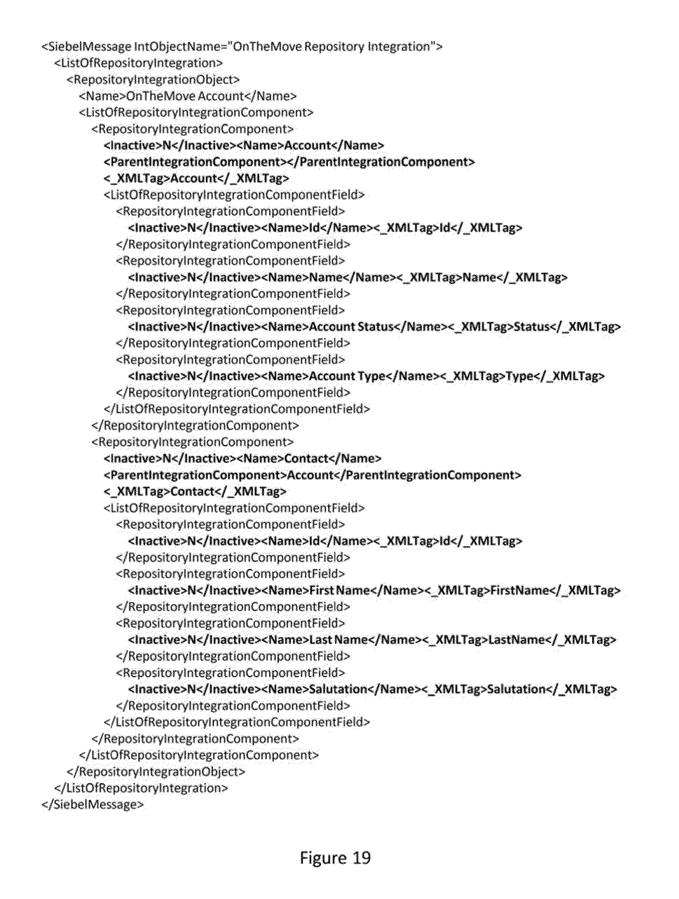

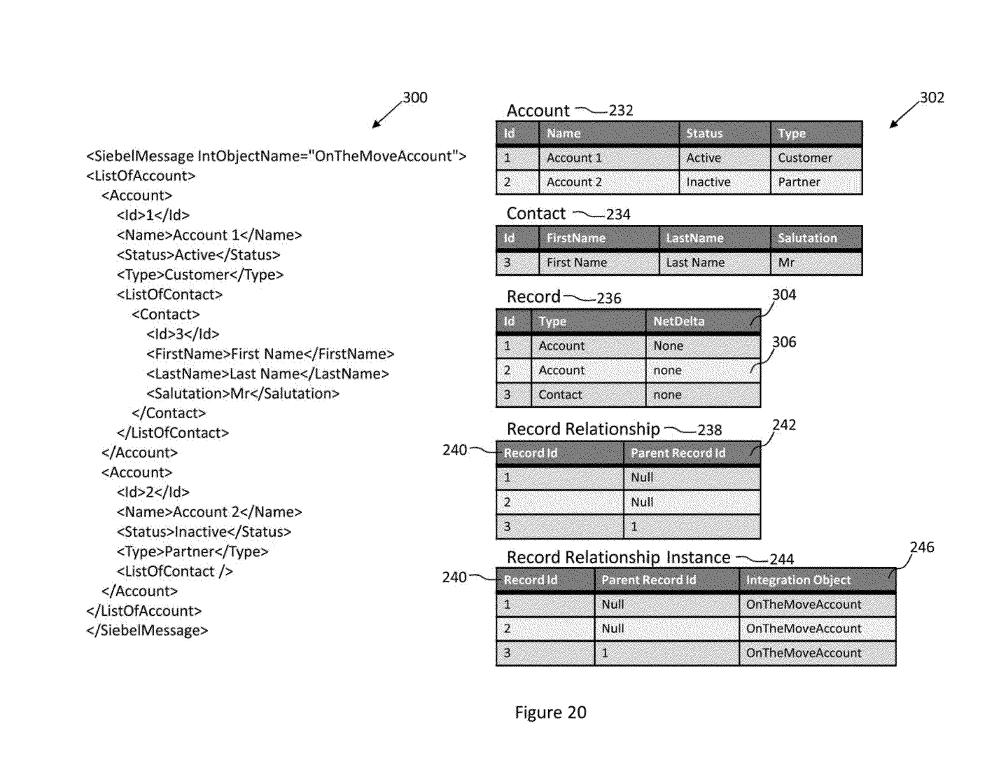

Most importantly, both the extraction logic and the synchronisation logic are governed automatically by the meta-data (data describing the structure and meaning of business data) already available in the central CRM database 22 or other database. This means that any customisation of the central system is automatically catered for in the extraction and synchronisation logic 24. The ‘metadata’ in one embodiment can be an Integration Object construct (described later with reference to FIGS. 19 and 20), which allows a hierarchical structure of a subset of the CRM data model to be defined. Data fitting that structure can then be exposed to external systems. Such metadata constructs have the general form (when visualised in an XML format) shown in FIG. 19: that is Integration Objects with child Integration Components with child Integration Component Fields.

An instance of one of these data structures (in this case representing the data held for Accounts and their child Contacts) would be as shown in FIG. 20. Therefore there are essentially three levels within a hierarchical structure of a subset of the CRM data model. Two of these are represented by metadata, but the third is actual user data. In this regard, FIG. 19 shows the first level where the general form of metadata constructs is provided, the next level comprises a specific implementation of metadata in this form (in the example provided: an Account integration object) and the third level as shown in FIG. 20 is the data generated by running that metadata implementation against the business layer (i.e. retrieving data).

The following describes one embodiment which uses, but is not limited to, Siebel CRM [I'm not sure it serves any purpose to take out this reference to Siebel so I have left this in for now] as an example. Also XML, being an established industry standard, is used as the representational format in this embodiment, but it is understood that the present embodiment could equally apply to any other representational format. In addition, the present embodiment assumes, but is not limited to using a relational database as the data store. Furthermore the present embodiment uses a HTML5 web browser supporting WebSQL, which allows the population of a SQLite relational database via a JavaScript API. The communications with CRM are implemented as AJAX HTTP calls.

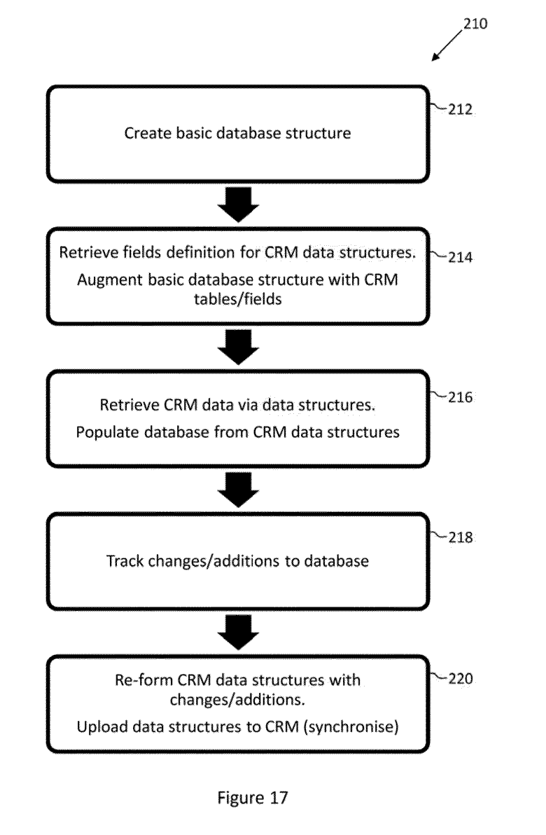

Referring to FIG. 17, a flow diagram showing a method 210 of setting up and using the mobile application in disconnected mode is now described. The method 210 commences with the creation at Step 212 of a basic database structure on the mobile device 200. The database structure is typically composed of tables and is stored in the local data store 206. It is a relational database which fully represents the XML structures of data to be downloaded from the master CRM application 202. The method continues with the retrieval at Step 214 of field definitions from the CRM data structures of the master CRM application 202. These field definitions are used to add to the basic database structure created in Step 212 with CRM tables and fields. Then the data from the CRM data structures of the master CRM application 202 is retrieved at Step 216 by the mobile CRM application and used to populate the database residing on the mobile device 202. This completes the set-up phase of the method 210 and the local database of the mobile CRM application is ready to use.

The mobile CRM application running on the mobile device 200 enables the user to access and interact with the data stored on the local CRM database. The mobile CRM application then tracks at Step 218 all interaction activity with the database (such as changes to the data, additions, and deletions) and records these in a tracking file in the local datastore 206. Finally, when the mobile CRM application comes back on-line, namely is no longer disconnected, then a synchronisation process at Step 220 takes place. This involves reforming the CRM-data structures to include all of the revisions of the data caused by the user interaction, namely the data stored in the tracking file. Then the reformed data structures are uploaded also at Step 220 to the central CRM 202 in a synchronisation step. Because the context or environment in which the mobile data interaction has been captured has been controlled to be compatible with the CRM 202, the synchronisation step is faster and less prone to error.

Having described the method of operation of the mobile CRM application operating in an offline or disconnected made, some of the above steps of the method are now described in greater detail below.

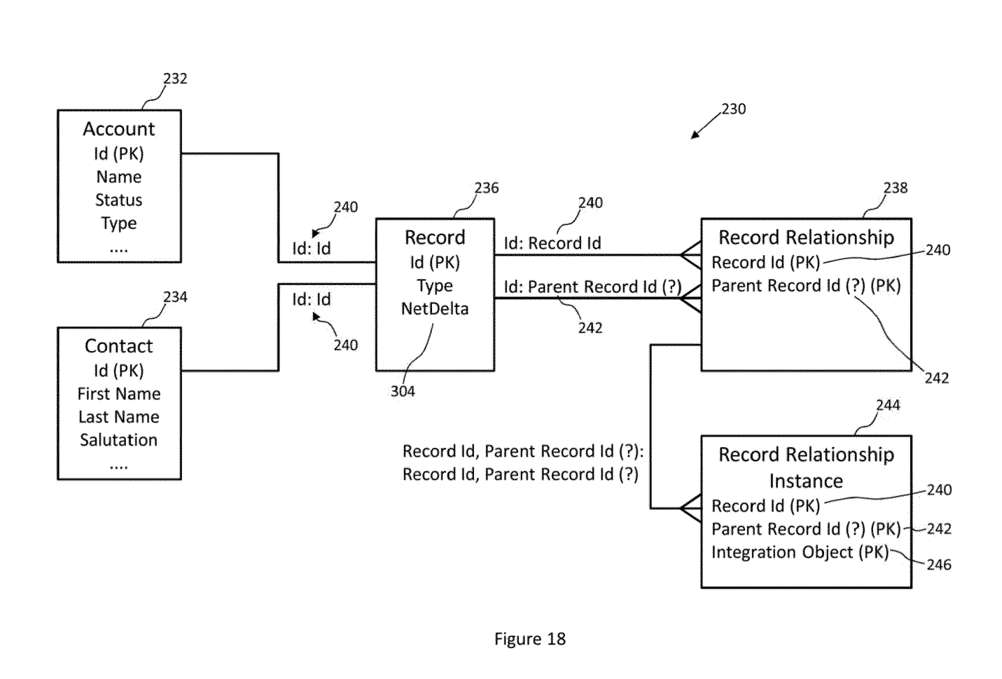

Referring to FIG. 18, the step of creating a local database structure (Step 212) is now described in greater detail.

Each XML data structure provided in the master CRM application 202 is seen as containing a plurality of ‘records’, each of which relate to an instance of a CRM object (such as Account, Contact, Opportunity, etc.). Each record contains child fields (containing the information for that Record) and (potentially) a set of child records, which are grouped by their type. Each record is required to contain one identifier field, which is in this non-limiting embodiment is named ‘Id’. This identifier field is used as the identifier for that record, which is important due to the fact that, for example, the same Contact record may appear under multiple Account records.

FIG. 18 shows an example of the structure 230 of the local CRM database. This example reflects a hierarchical XML database structure illustrated in FIG. 20 which is described in detail later. The hierarchical structure has Account records at the top most level, with child Contact records beneath, grouped into a <ListOfContact> element. A more complex structure may have additionally contained Order records under the Account records, which would have been grouped into a <ListOfOrder> element (however this is not shown in the present example).

In the local database structure 230 each record type is created as a table, for example an Account 232 and a Contact 234. These tables contain the fields for each record (i.e. the CRM data). Each record is also entered into a Record table 236 and a Record Relationship table 238, providing that no previous record has been entered with the same Id 240 (in the case of the Record table 236) and the same Record Id/Parent Record Id 240/242 (in the case of the Record Relationship table 238). The Id field 240 constitutes a primary key for the Record table 236, and a combination of the Record Id 240 and the Parent Record Id 242 for the Record Relationship table 238. Top level records receive an entry into Record Relationship table 238, with a blank Parent Record Id 242, in order to indicate that they exist at the top level for this data structure. The Record Relationship table 238 is seen to model the Record table 236 many to many with itself, enabling the modelling of the XML hierarchical relationships. However, the record type tables (e.g. Account 232 and Contact 234) are modelled one to one with the Record Table 236. Therefore each record of the Record Table is created providing that no previous record has been entered with the same Id 240 as any of the entries in the Account or Contact type tables 232,234.

It is to be appreciated that the Record table 236, the Record Relationship table 238 and the Record Relationship Instances 244 are always present in any local database structure which is created by this process. The record types Account 232 and Contact 234 are examples of object specific tables, the number, names and composition of is driven by the CRM data structure definitions. In FIG. 18 (PK) refers to a primary key column and (?) indicates that a column is optional (though all columns in the Account table 232 and the Contact table 234 except Id are assumed to be optional).

Also it is to be appreciated that XML documents typically cannot distinguish between one to many (1:M) and many to many (M:M) relationships. Both are simply shown as 1:M, with the child record repeated in its entirety across multiple parents if it is in fact M:M. The use of the primary keys mentioned previously and the requirement that each XML record contain an identifying Id field 240 advantageously allows the relational database in the mobile CRM application of the present embodiment to resolve both 1:M and M:M relationships correctly, such that the XML duplication is removed (i.e. only distinct Record entries are created), whilst retaining the multiple relationships (i.e. multiple Record Relationship entries are created). This is highly advantageous for correct and consistent subsequent editing of records within the offline disconnected mobile CRM application.

For the purposes of later reconstructing of the XML data structures when executing the upload synchronisation back to the master CRM application 202 at Step 220, it is necessary to record which record relationships were present in which XML structures (otherwise the master CRM application 202 will not be able to correctly process the returned data). Particular record relationships may be present in multiple data structures. As such, each time a record relationship is encountered, a Record Relationship Instance row 244 is created in the Record Relationship table 238, which refers to the appropriate Record Relationship row 244 and details the name of the data structure in which the relationship was found (column ‘Integration Object’ 246). As such, if the same record relationship is encountered in two different XML data structures, a single Record Relationship record is created, but with two different Record Relationship Instance records in the Record Relationship table 238.

Referring to FIG. 18, the step of retrieving field definitions (Step 214) from the CRM data structures of the master CRM application 202, is now described in greater detail.

The tables 232, 234 which are to hold the CRM data must be created based on the CRM data structures of the master CRM application 202. These structures define both the tables which should be created and the columns which they should comprise.

In one embodiment, a list of data structure names whose definitions are to be retrieved is held within the mobile application (e.g. in a configuration file). However, in another alternative embodiment, this list can be retrieved from the master CRM application 202.

One such approach for retrieving this list of information is to receive an XML response for each Integration Object 246 which is to be used as a data structure for database population. An integration object 246 is built over the ‘Repository Integration Object’ business object, which is then capable of retrieving the definition of any given integration object 246, its child integration components and their child integration component fields. This definition is converted to XML and returned in response to a web call which sends the target integration object name as an input. Only integration object definitions in the active repository are returned and inactive fields must be filtered out, either by excluding them from the XML response or sending an <inactive> field in the response with the understanding that the mobile device will ignore entries with a value other than ‘N’. Such an XML response from the master CRM application 202 is shown in FIG. 19, which details the structural definition of an integration object 246 (data structure) with Account records at the top level (with fields Id, Name, Status and Type) and child Contact records directly beneath (with fields Id, FirstName, LastName and Salutation). The <_XMLTag> element defines the name of the table/column, as these are the XML tags which are seen when the data structure itself is retrieved later. Also <inactive> fields are also clearly seen in the structure of the integration object 246.

Upon receiving the XML response shown in FIG. 19, the mobile application creates a table for each <RepositoryIntegrationComponent> (in this case Account 232 and Contact 234), with columns defined by the <_XMLTag> of the child <RepositoryIntegrationComponentField> elements.

This process is repeated for any other desired data structures, ready for receiving the data and populating the newly created tables.

If the same table is encountered in two or more integration object definitions, any columns not currently created as part of the local database table are added.

Referring to FIG. 18, the step of retrieving CRM data (Step 216) from the CRM data structures of the master CRM application 202 and populating the mobile application database is now described in greater detail.

For each required data structure, an HTTP call is made to the master CRM application 202, including the integration object name as an input. The response is XML data in the structure defined by that integration object 246 containing all records relevant to that user (defined by search expression rules configured within the master CRM application 202).

The local database tables are then populated in the manner described above in relation to Step 212. An example of such population for a single integration object 246 returning two accounts, one with a single child contact, is shown in FIG. 20, which shows an example XML structure 300 of a number of instances of an integration object 246. Also shown in FIG. 20 is a representation 302 of the resultant population of the various local relational database tables on the mobile device 200. The integration object definition structure is that previously retrieved as in FIG. 19.

Referring to FIG. 18, the step of tracking changes including additions and deletions to the local database on the mobile device (Step 218) is now described in greater detail.

As shown in FIG. 20, upon initial download, records have a NetDelta field 304 which are marked with a ‘NetDelta’ of ‘none’ 306, which indicates that the record has not been altered from that which was retrieved from master CRM application 202.

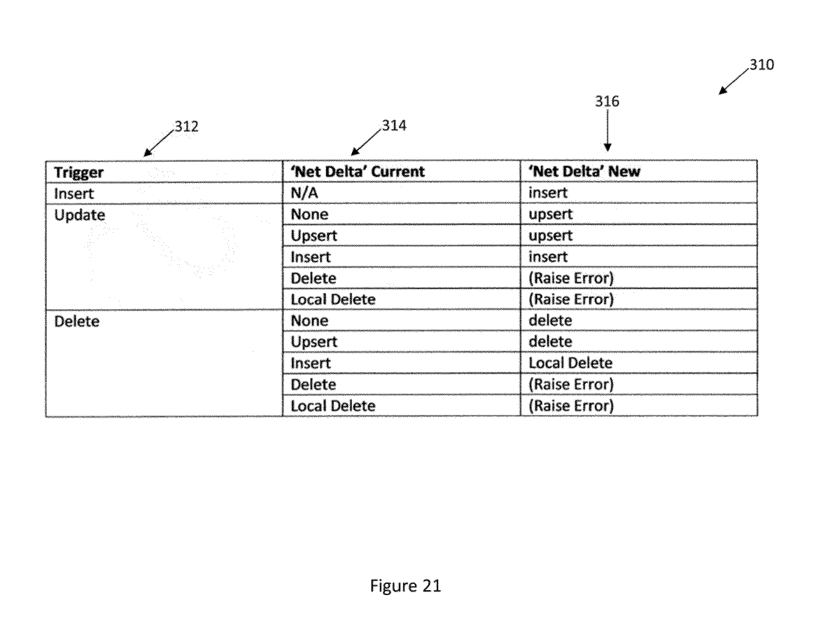

The user of the mobile CRM application may insert, update or delete records in certain circumstances (as defined by the construction of the offline application pages). As such alterations are performed, the ‘NetDelta’ field 304 of the appropriate record 236 is updated to the appropriate value, always indicating the overall type of change since the record was originally retrieved from master CRM application 202. FIG. 21 shows a table 310 of the various changes which may occur (the Triggers 312) the current ‘NetDelta’ value 314 and the resulting new ‘NetDelta’ value 316 required. Note that ‘Local Delete’ refers to records which have been created and subsequently deleted on the mobile device, having no net delta. These records are therefore simply ignored by the subsequent upload process (Step 220).

In practice, these rules are implemented by applying ‘instead of’ triggers to a database view ‘RecordView’ created over the Record table 236 (i.e. create view RecordView as select * from Record). The appropriate SQL operation (update/delete) is then made against this view (as well as separately to the specific data table, e.g. Account 232, in the case of an ‘update’ action) instead of the Record table directly. This view makes the appropriate net delta 304 change. Note that a ‘delete’ action does not therefore remove the record from the underlying Record table. When performing an ‘Insert’ action into the Record table, it is up to the mobile CRM application to apply the correct net delta of the ‘insert’ action directly, since there is no complex logic in this case (there being no prior net delta).

Referring to FIG. 18, the step of reforming the CRM data structures with the changes and additions and uploading the same to the master CRM application 202 (Step 220) for the purposes of synchronisation of the mobile CRM application with the master CRM application 202, is now described in greater detail.

A subset of the integration objects 246 used for download purposes is used in the upload process.

In order to reconstruct the XML with only the altered records, a JavaScript object ‘graph’ is first created which represents the correct hierarchical structure of the integration object 246 in question. Each record with a NetDelta value 314 other than ‘none’ or ‘Local Delete’ is added to the ‘graph’ object as a child object (at the appropriate depth) and has its column values added as child properties. Parent records required to build the ‘graph’ object with the correct hierarchy which have not themselves changed are included with only their Id field 240, in order to identify them to master CRM application 202 without actually making any changes. The record ‘NetDelta’ 304 is included as a child property of each record's object.

The structure required is understood through the use of the Record Relationship Instance table 244 described previously in FIG. 18. All changed records are included in all Record Relationship definitions relevant to the integration object 246 in question.

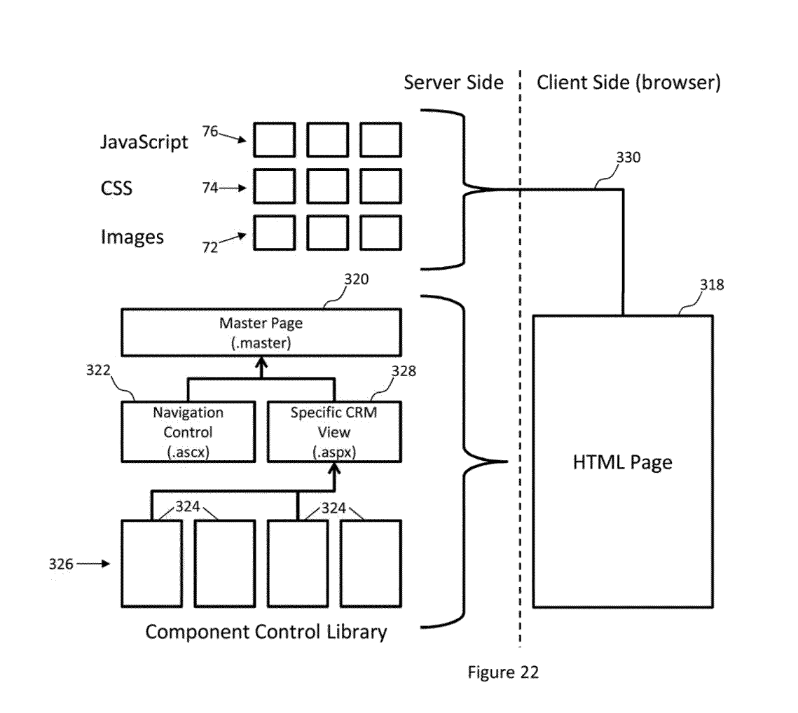

An example result is illustrated in FIG. 22. The example is consistent with the records populated in FIG. 20, with the account with Id 1 having been updated, contact with Id 3 having been updated and a new account (with Id 4) having been added. Note that had an account and its children not been altered it would not appear in the resultant data structure.

In the example shown in FIG. 20, two records are shown with with Id=1. Whilst this may appear to be incorrect, this is handled in one of two ways by the present embodiment. One simple way to address this is to provide a rule that the same data table in two integration objects must have the same fields defined. Alternatively, it is possible to use the ‘Ignore Undefined XML tags’ user property on the integration objects. In this latter case, the server simply ignores any fields encountered within the upload (reformulated) XML which are not part of that Integration object's definition. This enables the extension of the table with additional columns to resolve this issue.

In another embodiment, this object ‘graph’ may also be used to construct a user interface informing the user of the alterations which are to be synchronised back to the master CRM application 202. The resulting object graph is converted into XML in a generic manner by recursively navigating its structure.

Upon reconstructing the data structures for the purpose of synchronising changes back to the master CRM application 202, the NetDelta value 304 is used to instruct the master CRM application 202 as to which operation it should perform for each record. As such, the XML would take the form as in FIG. 20, except that each tag representing an integration component instance receives an ‘operation’ attribute set to one of ‘delete’, ‘insert’ or ‘upsert’. So, for example, <Contact> might become <Contact operation=“upsert”> and a new account may be added with the tag <Account operation=“insert”> (including all appropriate child fields, some of which CRM may require to successfully create the record). Parent records which have not been altered have their operation set to ‘skipnode’, instructing the master CRM application 202 to not attempt any update operations.

The master CRM application 202 accepts an HTTP call with the resulting XML as input, makes the appropriate changes indicated using the appropriate integration object 246 (defined in the XML) and reports back success or failure information. The master CRM application 202 is capable of understanding which record should be operated on through the use of the Id field 240, which the mobile CRM application always includes.

Returning now to FIG. 16, the method of generating mobile views 204 is now described. Having retrieved the master CRM application data into the local data store 206, it is necessary to build a mobile application comprising web pages which is capable of showing this data to the user, as well as allowing editing, removal and addition in keeping with the permitted actions of the master CRM application 202.

A useful feature for this standalone (disconnected) mobile application is that it offers a cut-down, limited feature-set to cater for business critical functions when the connected (integrated) application is unavailable. As the data synchronised back to the master CRM application 202 typically passes through the CRM business layer (logic module), full logic, process and validation is applied at this point, meaning that only an extremely cut down set of business logic is needed within the standalone mobile CRM application (those bits which are critical at the point of data entry).

One practical embodiment of the outlined approach is described in FIG. 22. Here ASP.NET Web Forms are used as the server-side technology. A web application project comprises the individual aspx web pages 318, each of which refer back to a master page file 320, which contains the standard wire frame definition (including navigation mark-up, for example, which may be included as a separate user control 322). These web pages make use of controls 324, sourced from a server controls library project 326 referenced by the web application project. These controls 324 drive the majority of the mark-up creation, the page developer simply assembling the desired controls 324 and providing the desired context for the view 328 in question. The page developer may in addition add their own logic (either server or client-side) to meet complex custom requirements.

FIG. 22 also shows how the resulting HTML page 318 from such a web application contains references to various static files 70, particularly images 72, CSS 74 and JavaScript files 76, which are then retrieved by subsequent requests 330 back to the web server 66.

The HTML pages 318 produced as illustrated in FIG. 22 differ from classic web pages in that they are not yet in a state ready to display to a user. Web pages are typically built using data and logic residing on the web server 66 in order to, for example, assemble a list with all child contacts for a given Opportunity (usually indicated through the use of a query string parameter in the requesting URL). For the purposes of an offline disconnected application, this is clearly inappropriate in the absence of a network connection.

As such, the web page 318 received by the client contains:
One or more data source definitions, defining the target data query for the view in question, to be executed against the local data store 206. This may include indicators that the data should be context specific, such that the client-side framework will always replace e.g. “<ParentRecordId>” with the query string parameter “ParentRecordId”.
One or more UI templates, tied to a specific data source. These define the ‘template’ layout to be repeated once per record found.
(Potentially as part of the above, or standalone) Action definitions, such as links, buttons etc. These drive the navigation around the offline solution and must construct the correct query-string parameters to drive the substitutions made by the data source definitions.

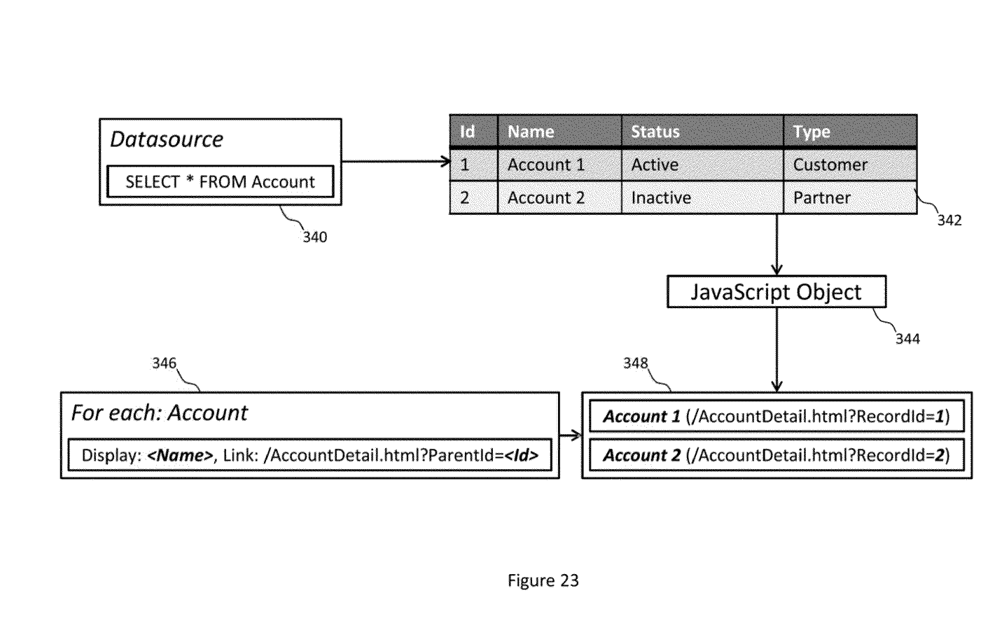

Consistent with these aforementioned components, FIG. 23 shows the steps (implemented with JavaScript) involved in constructing a view, being in this case an account list with links to drill down to a detailed view for each record. The name of each account is shown in order to identify it. FIG. 23 shows a simple data source 340 (in this case with no context driven search criteria), which retrieves data 342 from the local data store 206. This data is then converted into a JavaScript object ‘graph’ 344 and the result combined with the list template 346, resulting in the populated template 348 appearing once per record retrieved, which is displayed to the user.

In the case of a view allowing insertions, deletions and editing, the JavaScript object ‘graph’ 344 is kept up to date whenever the user makes changes within the UI. When the user clicks a ‘submit’ button (not shown), their changes are saved through the various update, delete and insert operations being recorded back into the local data store 206, in keeping with the delta tracking described above. Also any custom business logic for the implementation of complex rules/processes may be executed at this point, using JavaScript.

The control library 326 outlined in FIG. 22, includes controls capable of performing certain business logic actions, such as, but not limited to, required, range and format validations (potentially dependant on other field values in the result set) and the ability to set various fields when a record is ‘picked’ (e.g. setting the minimum order quantity when a product is selected for an order line item). More complex logic, if needed, can be implemented by the page developer.

Having described the different aspects of the present invention with reference to specific embodiments, it is to be appreciated that the present invention is not limited to the above described embodiments. Rather, as will be apparent to those skilled in the art, the present embodiments can be varied and the scope of this variation is determined by the spirit and scope of the present invention as determined by the appended claims.

The above-described embodiments utilise browser-based web applications. One variation would involve embedding these web applications within a native application, one purpose of which could be to access operating system features only available to native applications. This may be achieved via custom means or through purpose-built embedding-application frameworks.

The present embodiments are equally applicable to being varied for suitable use with non-touch devices such as laptop and desktop computers in scenarios where a truly customised user interface may be critical, such as in the case of customer self-service applications powered directly by a CRM.

The standalone application synchronisation outlined above performs a record level synchronisation, but it is seen as a clear and obvious extension for this synchronisation to be performed at the field level at some later date, such that only the fields which have been altered are sent back to CRM.

As stated above, the generic synchronisation and therefore whole standalone application, is readily applicable to various different CRM systems. In addition, although the integrated invention is highly tied to Siebel, the invention of a seamless combination of an integrated and standalone application to provide the best real world compromise to users is clearly applicable to other CRM systems onto which an integrated application can be applied.

As stated previously, although the standalone application embodiment utilises a local relational database this is not core to the technique or the problem it solves. As such, the technique clearly applies to any data store on the device, in particular, but not limited to, an Indexed DB.

The present embodiments have all been described in the context of a CRM application. However, various other applications exist to which the present embodiments would be similarly suited, such as ERP, Financial Management, HR Management, Procurement and Supply Chain Management. This is particularly true when such applications have heavily complex and configured processes and an additional need for some disconnected data access.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

The disclosure herein of any particular feature, aspect, method, property, characteristic, quality, attribute, element, or the like in connection with an embodiment can be used in all other embodiments set forth herein. For all of the embodiments described herein, the steps of the methods need not be performed sequentially. Thus, it is intended that the scope of the present invention herein disclosed should not be limited by the particular disclosed embodiments described above. The skilled artisan will recognize that any of the above-described methods can be carried out using any appropriate apparatus. All of the methods and tasks described herein may be performed and fully automated by a computer system. The computer system may, in some cases, include multiple distinct computers or computing devices (for example, physical servers, workstations, storage arrays, mobile devices, smartphones, or the like) that communicate and interoperate over a computer network to perform the described functions. Each such computing device typically includes a computer processor (or multiple computer processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (for example, ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state. For the embodiments implemented on a computer system, the system can be configured to process thousands of transactions and/or analyze transactions of at least 1000 users.

1. A database management system including a central database for storing records, the system being arranged to provide a Graphical User Interface (GUI) for a remotely-located mobile device to operatively interface to the central database, wherein the GUI comprises a hierarchy of graphical elements, the system further comprising:
a logic module for determining how to arrange and output information retrieved from records in the central database and for outputting that information in an XML form;
a user interface module arranged to convert the information in XML form output of the logic module into a mark-up language suitable for a browser in a mobile device, using XSLT stylesheets,
wherein the XLST stylesheets are organised in a hierarchical structure which maps onto the hierarchy of graphical elements within the GUI.

2. The database management system of claim 1, wherein the user interface module is arranged to use ‘include’ and ‘import’ commands of XLST to compose a view of the GUI.

3. The database management system of claim 1, wherein the hierarchy of graphical elements include a view comprised of a plurality of applets and wherein each applet has a corresponding stylesheet which can be called by the user interface module to compose the view.

4. The database management system of claim 3, wherein two or more applets are of a different type, with each different type having a different type of XSLT stylesheet.

5. The database management system of claim 3 or 4, wherein at least one applet comprises a plurality of controls each control being defined in a XSLT stylesheet which can be called by the user interface module to compose the applet.

6. The database management system of claim 5, wherein the at least one applet comprises at least two different types of control elements and each type of control element has a different XSLT stylesheet.

7. The database management system of claim 1, wherein the system is arranged as a Customer Relations Management (CRM) system.

8. A computer-implemented method of providing a Graphical User Interface (GUI) for operatively interfacing a remotely located mobile device to a database management system including a central database storing records, wherein the GUI comprises a hierarchy of graphical elements, the method comprising:
arranging and outputting information retrieved from records in the central database in an XML form;
converting the information in XML form into a mark-up language suitable for a browser in a mobile device, using XSLT stylesheets,
wherein the XLST stylesheets are organised in a hierarchical structure which maps onto the hierarchy of graphical elements within the GUI.

9. A computer-implemented method of creating a graphical user interface (GUI) representing data records stored in a central database suitable for viewing in a browser of a remote mobile device, the GUI comprising a plurality of graphical elements, the method comprising:
receiving information from the data records of the central database;
determining how to arrange and output the retrieved information and outputting that information in an XML form;
converting the information output in the XML form into a mark-up language using XSLT stylesheets;
wherein the determining step comprises using an XML parameter to specify an element type for a graphical element and the converting step comprises reading the element type parameter and retrieving a mark-up language code fragment associated with that type of graphical element.

10. The computer-implemented method of claim 9, wherein the graphical elements include applets and the determining step comprises determining which type of applet is to be specified by the XML parameter and the converting step comprises retrieving the mark-up language code fragment associated with that applet type.

11. The computer-implemented method of claim 10, wherein the type of applet is selected from the group comprising table applets, clickable list applets, expandable list applets, expandable list applets—portrait mode, detail form applets, attachment list applets, and map list applets.

12. The computer-implemented method of claim 9, wherein the determining step comprises using an XML parameter which has a primary function that does not specify the type of graphical element and a secondary function that does specify the type of the graphical element.

13. The computer-implemented method of claim 12, wherein the determining step comprises using an XML stylesheet tag parameter to include a name of the graphical element as the primary function and the type of the graphical element as the secondary function.

14. The computer-implemented method of claim 9, wherein the received information comprises a web template and the determining step comprises parsing the web template.

15. The computer-implemented method of claim 14, wherein the determining step comprises calling an XSLT stylesheet associated with the type of graphical element specified.

16. The computer-implemented method of claim 15, wherein the determining step comprises calling the same XSLT stylesheet associated with another graphical element of the same type.

17. The computer-implemented method of claim 14, wherein retrieved information comprises a child web template which is a subset of the web template and the determining step comprises parsing the child web template.

18. The computer-implemented method of claim 17, wherein the determining step comprises calling an XSLT stylesheet associated with the type of graphical element specified in the child web template and the retrieving step comprises retrieving a mark-up language code fragment associated with that child web template.

19. The computer-implemented method of claim 18, wherein the determining step comprises calling the same XSLT stylesheet associated with another graphical element of the same type in the child web template.

20. The computer-implemented method of claim 14, wherein the determining step comprises determining a web template which comprises at least part of another web template.

21. The computer-implemented method of claim 9, wherein the type of mobile device has been determined and the converting step comprises calling a container having an associated XSLT stylesheet specific to the type of mobile device, the XSLT stylesheet having been configured to the characteristics of the mobile device type.

22. The computer-implemented method of claim 21, wherein the characteristics of the mobile device comprise the screen size and/or resolution of the mobile device.

23. A module for creating a graphical user interface (GUI) representing data records stored in a central database suitable for viewing in a browser of a remote mobile device, the GUI comprising a plurality of graphical elements, the module comprising:
a receiver for receiving information from the data records of the central database;
a determining module for determining how to arrange and output the retrieved information and outputting that information in an XML form;
a convertor for converting the information output in the XML form into a mark-up language using XSLT stylesheets;
wherein the determining module is arranged to use an XML parameter to specify an element type for a graphical element and the convertor is arranged to read the element type parameter and retrieve a mark-up language code fragment associated with that type of graphical element.

24. A computer-implemented method of creating a graphical user interface (GUI) representing data records stored in a central database suitable for viewing in a browser of a remote mobile device, the method comprising:
Detecting the type of mobile device for which the GUI is to be generated;
Retrieving information from the data records of the central database;
determining how to arrange and output the retrieved information and outputting that information in an XML form; the determining step comprising selecting a user interface configuration matched to the type of mobile device detected by the detecting step;
converting the information output in the XML form into a mark-up language using XSLT stylesheets; the XSLT stylesheets conforming to the user interface configuration determined by the determining step; and
generating the GUI in a form compatible with the mobile device.

25. The computer-implemented method of claim 24, wherein the detecting step comprises detecting whether the mobile device is a mobile phone or a tablet computer.

26. The computer-implemented method of claim 24, further comprising:
constructing a plurality of GUIs for different types of mobile devices;
storing the generated GUIs at different URLs, each URL being associated with a different type of mobile device; and
receiving a request from the mobile device for an appropriate GUI,
wherein the detecting step comprises directing the request to the GUI associated with the detected type of the mobile device.

27. The computer-implemented method of claim 24, wherein the constructing step comprises using an object manager for each of the different types of mobile device, each object manager having its own configured graphical elements and web templates for each of the graphical components.

28. A web server arranged to create a graphical user interface (GUI) representing data records stored in a central database suitable for viewing in a browser of a remote mobile device, the web server comprising:
a detecting module for detecting the type of mobile device for which the GUI is to be generated;
an information retrieval module for retrieving information from the data records of the central database;
a determining module for determining how to arrange and output the retrieved information and outputting that information in an XML form; the determining module being arranged to select a user interface configuration matched to the type of mobile device detected by the detecting module;
a conversion module for converting the information output in the XML form into a mark-up language using XSLT stylesheets; the XSLT stylesheets conforming to the user interface configuration determined by the determining step; and
a generating module for generating the GUI in a form compatible with the mobile device.

29. A computer-implemented method of generating a Graphical User Interface (GUI) for output to a user terminal, the GUI providing a graphical representation of data records stored in a central database, the method comprising:
retrieving information from the data records of the central database; the information comprising value data of different data fields within a data record;
determining how to arrange and output the retrieved information and outputting that information in an XML form; the determining step including defining a plurality of graphical regions of the GUI each representing a record of the central database; and
converting the information output in the XML form into a mark-up language using XSLT stylesheets;
wherein the retrieving step comprises retrieving behavioural information with the value data, the behavioural information specifying a type of behaviour of a data record and the determining step comprises providing a graphical sub-element in the GUI representing that behaviour.

30. The computer-implemented method of claim 29, wherein the remote user terminal is a mobile device and the sending step comprises sending the view over a wireless communications network.

31. The computer-implemented method of claim 29, wherein the retrieving step comprises retrieving behavioural information in the form of an applet which specifies a type of behaviour and indicates which records in the current view that behaviour applies to.

32. The computer-implemented method of claim 31, wherein the applet is a list applet representing a list of the data records to be represented in the view of the GUI and whether each of the data records has the specific type of behaviour associated with that list applet.

33. The computer-implemented method of claim 31, wherein the retrieving step comprises retrieving a plurality of the list applets, each list applet relating to a different type of behaviour.

34. The computer-implemented method of claim 29, further comprising:
generating a first graphical sub-element indicative of the type of behaviour which has been specified for a first data record,
generating a second graphical sub-element indicative of the same type of behaviour which has been specified for a second data record, and
providing the first and second graphical sub-elements within the respective graphical regions of the first and second data records.

35. The computer-implemented method of claim 29, wherein the behavioural information relates to the ability to edit the data fields of the data record.

36. The computer-implemented method of claim 35, further comprising providing within the GUI a function to enable editing of simple fields across multiple graphical regions, each simple field being a constant field across multiple graphical regions.

37. A module for generating a Graphical User Interface (GUI) for output to a user terminal, the GUI providing a graphical representation of data records stored in a central database, the module comprising:
a retriever for retrieving information from the data records of the central database; the information comprising value data of different data fields within a data record;
a determining module for determining how to arrange and output the retrieved information and outputting that information in an XML form; the determining module being arranged to define a plurality of graphical regions of the GUI each representing a record of the central database; and
a convertor for converting the information output in the XML form into a mark-up language using XSLT stylesheets;
wherein the retriever is arranged to retrieve behavioural information with the value data, the behavioural information specifying a type of behaviour of a data record and the determining module is arranged to provide a graphical sub-element in the GUI representing that behaviour.

38. A module for synchronising offline activity occurring on a database of a mobile device with a central database of a database management system, the offline activity occurring when the mobile device is not able to communicate with the database management system, the module comprising:
a receiver for receiving information describing a data structure provided within the central database from the database management system and content data for the data structure;
applying means for applying the received information to a basic database structure provided on the mobile device and storing the resultant tailored database as a serialised data structure in a data store of the mobile device;
population means for populating the serialised data structure with the received content data;
a user interface generator for generating a graphical user interface on a browser of the mobile device using the database structure and displaying the received data; the user interface being arranged to enable user editing of or addition to the received data;
tracking means arranged to track all user changes to the received data; and
synchronisation means for synchronising the mobile device database with the central database by uploading the data of the mobile device database to the central database when the mobile device can operatively communicate with the database management system over a communications channel.

39. The module of claim 38, wherein the received information comprises database field definitions and the applying means is arranged to apply the field definitions to the basic data structure to create a database structure which is compatible with the structure of the central database.

40. The module of claim 38, wherein the synchronisation means is arranged to apply all of the tracked changes to the database structure of the tailored database and to upload the resultant data structure to the database management system.

41. The module of claim 40, wherein the synchronisation means is arranged to upload the database records of the tailored database structure where there have been changes due to the tracked changes and to upload references to the database records where there have been no changes.

42. The module of claim 38, wherein the receiver is arranged to receive the content data for the data structure once the applying means has applied the received information to the basic database structure.

43. The module of claim 38, wherein the applying means is arranged to apply the received data to create a table data structure.

44. The module of claim 38, wherein the tracking means is arranged to populate records of the tailored database with a tracking variable representing the cumulative effect of the user changes to the data record.

45. The module of claim 38, wherein the central database comprises a plurality of records, each of which relate to an instance of a database object and each record contains child fields and a set of child records, which are grouped by their type.

46. The module of claim 38, wherein the basic database structure, comprises a table of data records, a table of relationships between records and a table of record relationship instances, wherein the record relationship instances enable many parent record to many child record relationships to be efficiently recorded.

47. The module of claim 46, wherein each of the table of data records, the table of relationships between records and the table of record relationship instances, comprise a Parent record identifier field, which is used as an identifier for that record's parent.

48. The module of claim 46, wherein table of record relationship instances comprises an integration object which details the name of the data structure in which the relationship was found to be present.

49. The module of claim 45, wherein the tailored database comprises a plurality of records, and each record comprises an identifier field, which is used as the identifier for that record.

50. The module of claim 38, wherein the received information comprises data structure definitions and the applying means is arranged to create object specific tables, wherein the number and composition of the object specific tables is determined by the received data structure definitions and wherein the tailored database comprises the combination of the object specific tables and the basic database structure.

51. The module of of claim 38, wherein the receiver is arranged to extract information from the central database using metadata present in the central database describing the information stored therein.

52. The module of claim 38, wherein the synchronisation means is arranged to synchronise data back to the central database using metadata present in the central database describing the information stored therein.

53. A computer-implemented method of synchronising offline activity occurring on a database of a mobile device with a central database of a database management system, the offline activity occurring when the mobile device is not able to communicate with the database management system, the method comprising:
receiving information describing a data structure provided within the central database from the database management system;
applying the received information to a basic database structure provided on the mobile device;
storing the resultant tailored database as a serialised data structure in a data store of the mobile device;
receiving content data for the data structure and populating the serialised data structure with the received content data;
generating a graphical user interface on a browser of the mobile device using the database structure, displaying the received data and enabling user editing of or addition to the received data;
tracking all user changes to the received data; and
synchronising the mobile device database with the central database by uploading the data of the mobile device database to the central database when the mobile device can operatively communicate with the database management system over a communications channel.

54. A module for generating a graphical user interface (GUI) on a browser of a mobile device, the module being operable in an online mode with user-interaction activity occurring with a central database of a database management system and in an offline mode with user-interaction activity occurring with a local database of the mobile device when the mobile device is not able to communicate with the central database management system, the module comprising:
a receiver for receiving metadata information describing data provided within the central database of the database management system; and
a user interface generator arranged to generate the GUI for the on-line mode using a database structure provided by the central database management system and for generating the GUI for the off-line mode using a local database structure to which the received metadata information has been applied.

55. The module of claim 54, wherein the user interface generator is arranged to generate a wireframe for the GUI which includes a navigation region, the navigation region having a first displayed portion providing user navigation controls for use in the on-line mode and a second displayed portion providing user navigation controls for use in the off-line mode.

56. The module of claim 54, wherein the user interface generator is arranged to generate branding region in which content is displayed which is common to both the on-line mode and the off-line mode.

57. The module of claim 54, wherein the user interface generator is arranged to generate a content region, the content region displaying on-line content from the central database when operating in the on-line mode and off-line information from the local database when operating in an off-line mode.

58. The module of claim 54, wherein the receiver is arranged to receive metadata information describing the data structure of the central database.

59. The module of claim 58, further comprising applying means for applying the received metadata information to a database structure provided in the local database of the mobile device, the metadata information describing the data and database structure of the central database.

60. The module of claim 59, wherein the applying means is arranged when in offline mode to configure the local database to provide a subset of the set of processes available from the central database in online mode.

61. A computer-implemented method of generating a graphical user interface (GUI) on a browser of a mobile device, the method operating in an online mode with user-interaction activity occurring with a central database of a database management system and in an offline mode with user-interaction activity occurring with a local database of the mobile device when the mobile device is not able to communicate with the central database management system, the method comprising:
receiving metadata information describing data provided within the central database of the database management system;
applying the received metadata to a local database structure for off-line use; and
generating the GUI for the on-line mode using a database structure provided by the central database management system and generating the GUI for the off-line mode using the local database structure to which the received metadata information has been applied.

62. A computer-implemented method of providing a Graphical User Interface (GUI) for operatively interfacing a remotely located mobile device to a database management system, wherein the GUI represents data records stored in the central database suitable for viewing in a browser of a remote mobile device and the GUI comprises a hierarchy of graphical elements, the method comprising:
detecting the type of mobile device for which the GUI is to be generated;
retrieving information from the data records of the central database;
arranging and outputting information retrieved from records in the central database in an XML form, the arranging step including using an XML parameter to specify an element type for a graphical element and selecting a user interface configuration matched to the type of mobile device detected by the detecting step; and
converting the information in XML form into a mark-up language suitable for a browser in the mobile device, using XSLT stylesheets, the XLST stylesheets being organised in a hierarchical structure which maps onto the hierarchy of graphical elements within the GUI and conforms to the selected user interface configuration, the converting step including reading the element type parameter and retrieving a mark-up language code fragment associated with that type of graphical element.

63. The computer-implemented method of claim 62, wherein the graphical elements include applets and the arranging and outputting step comprises determining which type of applet is to be specified by the XML parameter and the converting step comprises retrieving the mark-up language code fragment associated with that applet type.

64. The computer-implemented method of claim 63, wherein the type of applet is selected from the group comprising table applets, clickable list applets, expandable list applets, expandable list applets—portrait mode, detail form applets, attachment list applets, and map list applets.

65. The computer-implemented method of claim 62, wherein the arranging and outputting step comprises using an XML parameter which has a primary function that does not specify the type of graphical element and a secondary function that does specify the type of the graphical element.

66. The computer-implemented method of claim 65, wherein the arranging and outputting step comprises using an XML stylesheet tag parameter to include a name of the graphical element as the primary function and the type of the graphical element as the secondary function.

67. The computer-implemented method of claim 62, wherein the retrieved information comprises a web template and the arranging and outputting step comprises parsing the web template.

68. The computer-implemented method of claim 67, wherein the arranging and outputting step comprises calling an XSLT stylesheet associated with the type of graphical element specified.

69. The computer-implemented method of claim 68, wherein the arranging and outputting step comprises calling the same XSLT stylesheet associated with another graphical element of the same type.

70. The computer-implemented method of claim 67, wherein retrieved information comprises a child web template which is a subset of the web template and the arranging and outputting step comprises parsing the child web template.

71. The computer-implemented method of claim 70, wherein the arranging and outputting step comprises calling an XSLT stylesheet associated with the type of graphical element specified in the child web template and the retrieving step comprises retrieving a mark-up language code fragment associated with that child web template.

72. The computer-implemented method of claim 71, wherein the arranging and outputting step comprises calling the same XSLT stylesheet associated with another graphical element of the same type in the child web template.

73. The computer-implemented method of any of claims 67 to 72, wherein the arranging and outputting step comprises determining a web template which comprises at least part of another web template.

74. The computer-implemented method of any of claims 62 to 73, wherein the type of mobile device has been determined and the converting step comprises calling a container having an associated XSLT stylesheet specific to the type of mobile device, the XSLT stylesheet having been configured to the characteristics of the mobile device type.

75. The computer-implemented method of claim 74, wherein the characteristics of the mobile device comprise the screen size and/or resolution of the mobile device.

76. A computer-implemented method of claim 62, wherein converting step includes using ‘include’ and ‘import’ commands of XLST to compose a view of the GUI.

77. A computer-implemented method of claim 62, wherein the hierarchy of graphical elements include a view comprised of a plurality of applets and the converting step comprises calling a corresponding XSLT stylesheet for each applet to compose the view.

78. A computer-implemented method of claim 77, wherein two or more applets are of a different type, with each different type having a different type of XSLT stylesheet and the converting step comprises calling each of the different types of XSLT stylesheet.

79. A computer-implemented method of claim 77, wherein at least one applet comprises a plurality of controls each control being defined in a XSLT stylesheet and the converting step comprises calling a corresponding XSLT stylesheet for each control to compose the view.

80. A computer-implemented method of claim 79, wherein the at least one applet comprises at least two different types of control elements and each type of control element has a different XSLT stylesheet and the converting step comprises calling each of the different types of XSLT stylesheet for the control elements.

81. A computer-implemented method of claim 62, wherein retrieving step comprises retrieving information from data records of the central database which is arranged as a Customer Relations Management (CRM) system.

82. The computer-implemented method of claim 62, wherein the detecting step comprises detecting whether the mobile device is a mobile phone or a tablet computer.

83. The computer-implemented method of claim 62, further comprising:
constructing a plurality of GUIs for different types of mobile devices;
storing the generated GUIs at different URLs, each URL being associated with a different type of mobile device; and
receiving a request from the mobile device for an appropriate GUI,
wherein the detecting step comprises directing the request to the GUI associated with the detected type of the mobile device.

84. The computer-implemented method of claim 83, wherein the constructing step comprises using an object manager for each of the different types of mobile device, each object manager having its own configured graphical elements and web templates for each of the graphical components.
